(19) United States
(12) Patent Application Publication
(10) Pub. No.: US 2024/0354373 A1
(43) Pub. Date: Oct. 24, 2024

(54) INFORMATION PROCESSING APPARATUS, INFORMATION PROCESSING SYSTEM, INFORMATION PROCESSING METHOD, AND NON-TRANSITORY RECORDING MEDIUM

(71) Applicant: Genki Watanabe, TOKYO (JP)

(72) Inventor: Genki Watanabe, TOKYO (JP)

(73) Assignee: Ricoh Company, Ltd., Tokyo (JP)

(21) Appl. No.: 18/628,037

(22) Filed: Apr. 5, 2024

(30) Foreign Application Priority Data
Apr. 19, 2023 (JP) 2023-068776

(51) Int. Cl. G06F 18/21; G06F 18/22

(52) U.S. Cl. CPC G06F 18/217; G06F 18/22

(57) ABSTRACT

An information processing apparatus includes: circuitry configured to: evaluate similarity between first feature information and second feature information for each of multiple items of data, the first feature information indicating a feature of the data, the second feature information indicating a feature of a first character string designated in input information; evaluate, for a collection of data including the multiple items of data, a state of variation of the first feature information of the items of data belonging to the collection of data; and generate display information of a screen that displays the collection of data in a mode based on a result of evaluation of the similarity and a result of evaluation of the state of variation.

### CROSS-REFERENCE TO RELATED APPLICATIONS

This patent application is based on and claims priority pursuant to 35 U.S.C. § 119(a) to Japanese Patent Application No. 2023-068776, filed on Apr. 19, 2023, in the Japan Patent Office, the entire disclosure of which is hereby incorporated by reference herein.

### BACKGROUND

### Technical Field

The present disclosure relates to an information processing apparatus, an information processing system, an information processing method, and a non-transitory recording medium.

### Related Art

Users, such as persons involved in business activities within and outside an office, may desire to collect and use various information such as materials useful for their work, personnel information, and organizational knowledge.

### SUMMARY

According to an embodiment of the present disclosure, an information processing apparatus includes circuitry. The circuitry evaluates similarity between first feature information and second feature information for each of multiple items of data. The first feature information indicates a feature of the data. The second feature information indicates a feature of a first character string designated in input information. The circuitry evaluates, for a collection of data including the multiple items of data, a state of variation of the first feature information of the items of data belonging to the collection of data. The circuitry generates display information of a screen that displays the collection of data in a mode based on a result of evaluation of the similarity and a result of evaluation of the state of variation.

According to an embodiment of the present disclosure, an information processing system includes circuitry. The circuitry evaluates similarity between first feature information and second feature information for each of multiple items of data. The first feature information indicates a feature of the data. The second feature information indicates a feature of a first character string designated in input information. The circuitry evaluates, for a collection of data including the multiple items of data, a state of variation of the first feature information of the items of data belonging to the collection of data. The circuitry causes a display to display a screen that displays the collection of data in a mode based on a result of evaluation of the similarity and a result of evaluation of the state of variation.

According to an embodiment of the present disclosure, an information processing method includes evaluating similarity between first feature information and second feature information for each of multiple items of data, the first feature information indicating a feature of the data, the second feature information indicating a feature of a first character string designated in input information; evaluating, for a collection of data including the multiple items of data, a state of variation of the first feature information of the items of data belonging to the collection of data; and generating display information of a screen that displays the collection of data in a mode based on a result of evaluation of the similarity and a result of evaluation of the state of variation.

According to an embodiment of the present disclosure, a non-transitory recording medium storing a plurality of instructions which, when executed by one or more processors, causes the processors to perform an information processing method including evaluating similarity between first feature information and second feature information for each of multiple items of data, the first feature information indicating a feature of the data, the second feature information indicating a feature of a first character string designated in input information; evaluating, for a collection of data including the multiple items of data, a state of variation of the first feature information of the items of data belonging to the collection of data; and generating display information of a screen that displays the collection of data in a mode based on a result of evaluation of the similarity and a result of evaluation of the state of variation.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating an example configuration of an information processing system according to a first embodiment;

FIG. 2 is a diagram illustrating an example hardware configuration of an information collection apparatus according to the first embodiment;

FIG. 3 is a diagram illustrating an example functional configuration of the information processing system according to the first embodiment;

FIG. 4 is a flowchart illustrating an example procedure of an information collection process according to the first embodiment;

FIG. 5 is an illustration of an example of a collection-condition input screen according to the first embodiment;

FIG. 6 is a diagram illustrating an example configuration of a document vector storage unit;

FIG. 7 is a diagram illustrating an example configuration of a workspace storage unit;

FIG. 8 is an illustration of an image of states of variations of respective workspaces according to an embodiment of the present disclosure;

FIG. 9 is a table illustrating an example of workspaces to describe a method for calculating a degree of variation of a workspace;

FIG. 10 is a table illustrating an example of results of principal component analysis of the respective workspaces;

FIG. 11 is an illustration of a first example of a displayed search result screen;

FIG. 12 is an illustration of a second example of the displayed search result screen;

FIG. 13 is an illustration of a third example of the displayed search result screen;

FIG. 14 is a flowchart illustrating an example procedure of an information collection process according to a second embodiment;

FIG. 15 is an illustration of an example of a collection-condition input screen according to the second embodiment;

FIG. 16 is a chart illustrating an evaluation of the states of variations of workspaces on an evaluation axis according to an embodiment of the present disclosure;

FIG. 17 is an illustration of an example of a setting screen according to a third embodiment;

FIG. 18 is a flowchart illustrating an example procedure of an information collection process according to the third embodiment;

FIG. 19 is an illustration of an example of a collection-condition input screen according to a fourth embodiment;

FIG. 20 is a chart illustrating an evaluation of the states of variations of workspaces in a semantic space from which a removal item is removed according to an embodiment of the present disclosure;

FIG. 21 is a flowchart illustrating an example procedure of an information collection process according to a sixth embodiment;

FIG. 22 is a diagram illustrating an example functional configuration of an information processing system according to a seventh embodiment; and

FIG. 23 is a flowchart illustrating an example procedure of a process performed by the information collection apparatus according to the seventh embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

One or more embodiments of the present disclosure provide an information processing apparatus, an information processing system, an information processing method, and a non-transitory recording medium storing a program for improving the convenience of information collection.

For example, in various departments of a company, such as planning, research and development, and human resources, many documents such as proposals and reports are created every day, and various information (such as previous minutes, proposals, reports, designs, and papers) are present as in-house assets. Such information (information including, for example, documents and personnel information) scattered across the company is enormous, and it may be difficult for a user to use such information assets to create a proposal or a report.

Results of collected information depend on a character string provided as input. Depending on, for example, the experience or skill level of the user for information collection, it may take a considerable amount of time to collect information, or appropriate information may be difficult to find. Such issues are not fully addressed by existing techniques, and it is therefore desired to improve the convenience of collecting desired information.

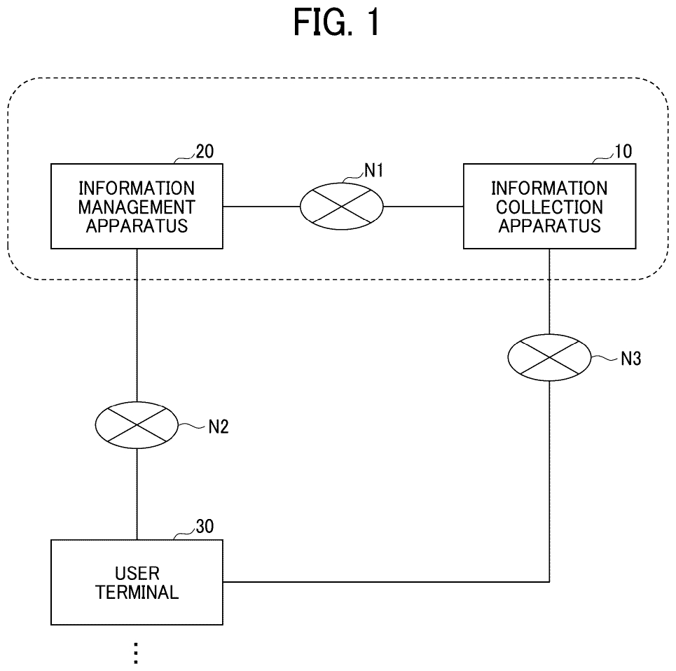

Embodiments of the present disclosure will be described hereinafter with reference to the drawings. FIG. 1 is a diagram illustrating an example configuration of an information processing system according to a first embodiment. In FIG. 1, the information processing system includes, for example, an information management apparatus 20, an information collection apparatus 10, and one or more user terminals 30. The information collection apparatus 10 is connected to the information management apparatus 20 via a network N1. Each user terminal 30 is connected to the information management apparatus 20 via a network N2 and connected to the information collection apparatus 10 via a network N3.

The user terminal 30 is a terminal used by a user who desires to collect certain information (or access certain information). Examples of the user terminal 30 include a personal computer (PC), a tablet terminal, and a smartphone. In the present embodiment, a workspace is an example of information that a user desires to collect. The workspace is a collection of one or more items of document information (document data).

The document information is information including, for example, attribute information or bibliographic information related to electronic data in which a document is recorded. Such electronic data is hereinafter referred to as “document data”. The document is a collection of one or more words or sentences. In one example, the document includes alphanumeric characters and other multilingual characters. The document data may be data in any format in which sentences are represented. In one example, the document data may be data representing a document in a text format or data in a format specialized for a specific application. In another example, the document data may be data representing a word or a sentence itself or a concept corresponding to the word or the sentence in the form of, for example, an image, a voice, or a video (moving image). In other words, the document data may be image data, audio data, or video data. Further, the storage format of the document data is not limited to any specific one. In one example, the document data may be stored in a file. In another example, the document data may be stored as a record in a database. The document data may be stored in any other format. In the present embodiment, the document data is stored in a file (hereinafter simply referred to as “file”), by way of example.

The term “workspace” refers to data for associating a collection of document information collected (retrieved) under the same condition in the previous collection of document information using the information processing system. In other words, one workspace is a set of one or more elements that are one or more items of document information (document data). Each workspace is editable, and document information may be added to the workspace or deleted from the workspace in accordance with an instruction given from the user. Since each workspace is a collection of document information having in common a feature of being collected (retrieved) under the same condition, workspaces are collected to provide efficient collection of multiple items of document information having a predetermined relationship.

The information management apparatus 20 includes one or more computers that store, for example, document information, a file that is the actual body of the document information, and information related to a workspace.

The information collection apparatus 10 includes one or more computers that provide information to the user terminal 30 in response to a request input by the user. In one example, in response to a collection request for document information, the information collection apparatus 10 searches for document information under a condition specified in the collection request, and transmits a search result to the user terminal 30. In another example, in response to a collection request for workspaces, the information collection apparatus 10 searches for a workspace under a condition specified in the collection request, and transmits a search result to the user terminal 30.

In one embodiment, the information management apparatus 20 and the information collection apparatus 10 may be integrated into one device such as one computer. In this case, the network N1 corresponds to a signal line such as a bus in the computer or computers included in the information management apparatus 20 and the information collection apparatus 10. In another embodiment, each user terminal 30 also serves as the information collection apparatus 10. In this case, the network N3 corresponds to a signal line such as a bus in the user terminal 30.

The scene (situation) in which the information processing system is used is not limited to any specific one. In one example, the information processing system may be used in a company. Each member of the company may be a user. Examples of the company include businesses, government agencies, organizations, and associations. The members of the company include employees, temporary employees, contract employees, and part-time employees. In the present embodiment, each member of the company is referred to as a user, by way of example, but not limitation. In some embodiments, the information processing system is used by a general user.

In this case, the information management apparatus 20 includes a group of computers that store files present in the company. For example, the information management apparatus 20 manages, for example, document information related to various document data created in the company, and workspaces as a result of collection of document information performed in the company. In this case, the network N2 corresponds to, for example, a wide area network (WAN) or a local area network (LAN) in the company.

In one embodiment, the information collection apparatus 10 may be installed in the company. In another embodiment, the information collection apparatus 10 may be installed outside the company. For example, the information collection apparatus 10 may be installed in a cloud environment such as a data center, which is connected to a network in the company via the Internet. In a case where the information collection apparatus 10 is installed in the company, each of the networks N1 and N3 corresponds to, for example, a WAN or a LAN in the company. In a case where the information collection apparatus 10 is installed outside the company, each of the networks N1 and N3 corresponds to, for example, the Internet. The information collection apparatus 10 may collect information desired by the user from information disclosed outside the company.

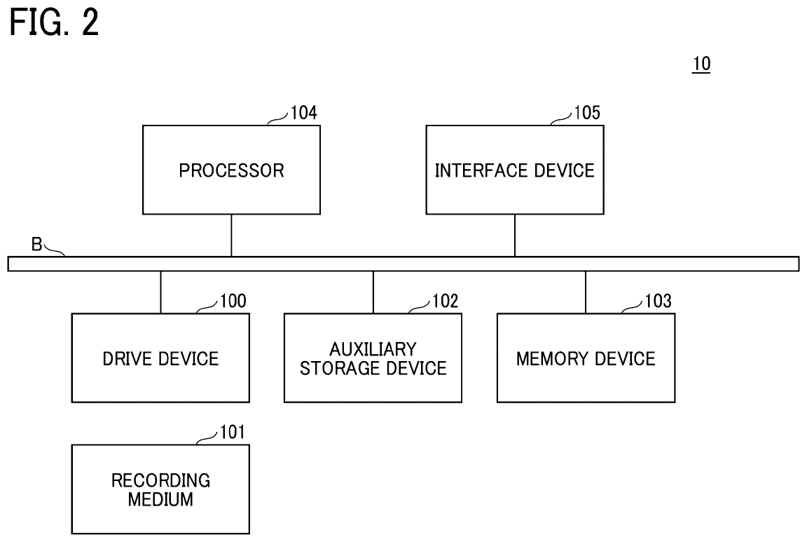

FIG. 2 is a diagram illustrating an example hardware configuration of the information collection apparatus 10 according to the first embodiment. The information collection apparatus 10 illustrated in FIG. 2 includes, for example, a drive device 100, an auxiliary storage device 102, a memory device 103, a processor 104, and an interface device 105, which are connected to one another via a bus B.

A program that implements processing performed by the information collection apparatus 10 is provided via a recording medium 101 such as a compact disc read-only memory (CD-ROM). In response to the recording medium 101, which stores the program, being set in the drive device 100, the program is installed into the auxiliary storage device 102 from the recording medium 101 through the drive device 100. In one example, the program is not installed from the recording medium 101, but is downloaded from another computer via a network. The auxiliary storage device 102 stores the installed program and also stores desired files, data, and so on.

In response to an instruction to activate the program, the memory device 103 reads the program from the auxiliary storage device 102 and stores the read program. The processor 104 includes a central processing unit (CPU) or a graphics processing unit (GPU), or includes a CPU and a GPU. The processor 104 implements the functions of the information collection apparatus 10 in accordance with the program stored in the memory device 103. The interface device 105 is used as an interface for connecting to the network.

The information management apparatus 20 and the user terminal 30 may also have a hardware configuration similar to that illustrated in FIG. 2.

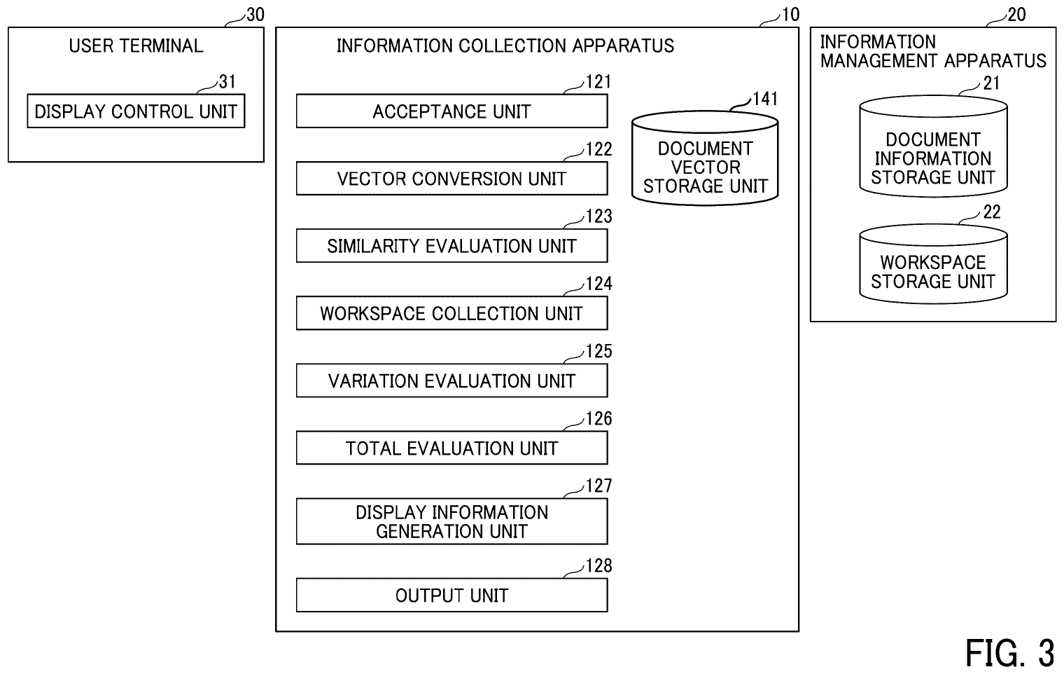

FIG. 3 is a diagram illustrating an example functional configuration of the information processing system according to the first embodiment. In FIG. 3, the user terminal 30 includes a display control unit 31. The display control unit 31 is implemented by processing performed by a processor of the user terminal 30 in accordance with one or more programs (e.g., a web browser program) installed in the user terminal 30.

The display control unit 31 displays a screen based on display information transmitted from the information collection apparatus 10 or transmits a request corresponding to an input to the screen to the information collection apparatus 10.

The information management apparatus 20 includes, for example, a document information storage unit 21 and a workspace storage unit 22. In one embodiment, the document information storage unit 21 and the workspace storage unit 22 are each implemented using, for example, an auxiliary storage device of the information management apparatus 20.

The document information storage unit 21 stores document information of document data. Document data is stored in, for example, the auxiliary storage device of the information management apparatus 20.

The workspace storage unit 22 stores information related to a workspace. The information related to a workspace is, for example, a collection of document information included in a result of collected information corresponding to the workspace.

The information collection apparatus 10 includes an acceptance unit 121, a vector conversion unit 122, a similarity evaluation unit 123, a workspace collection unit 124, a variation evaluation unit 125, a total evaluation unit 126, a display information generation unit 127, and an output unit 128. Each unit is implemented by processing performed by the processor 104 in accordance with one or more programs installed in the information collection apparatus 10. The information collection apparatus 10 also includes a document vector storage unit 141. In one embodiment, the document vector storage unit 141 is implemented using, for example, the auxiliary storage device 102 or a storage device connectable to the information collection apparatus 10 via a network.

The acceptance unit 121 receives (accepts) a collection request for information desired by the user from the user terminal 30. The collection request for information includes, as input information, a condition (collection condition) for collecting information (in the present embodiment, workspaces). The collection condition includes a character string representing the information to be collected in a natural language, and an evaluation criterion for semantic variations of the content of the document data belonging to the workspaces. The character string is hereinafter referred to as “query”. The evaluation criterion is hereinafter referred to as “variation evaluation criterion”). The variation evaluation criterion includes any one of the following: assigning ratings to the states of variations such that the rating increases as the variation increases; assigning ratings to the states of variations such that the rating increases as the variation decreases; and assigning no rating to the states of variations.

The query is, for example, a collection of one or more words. In one example, the query is a list of one or more words. In another example, the query has the form of one or more sentences. The variation evaluation criterion is a condition indicating whether to preferentially collect a workspace with a small semantic variation of the content of the document data or preferentially collect a workspace with a large semantic variation of the content of the document data.

The vector conversion unit 122 analyzes the query included in the collection condition, or document data of document information stored in the document information storage unit 21. Further, the vector conversion unit 122 converts the query or the document data into data in a numerical vector format, which is an example of feature information (feature value) indicating a semantic feature of the query or the document data. The data in such a numerical vector format is hereinafter referred to as “semantic vector”. The semantic vector is also referred to as a distributed representation or an embedding and is a representation of the meaning of the original data (such as the query or the document data) from which the semantic vector is obtained as a result of conversion. The vector conversion unit 122 generates the semantic vector by using, for example, natural language processing such as Bidirectional Encoder Representations from Transformers (BERT). The attribute of the user may be used to switch models for BERT. The vector conversion unit 122 generates vectors of document data in advance and records the vectors in the document vector storage unit 141. In the following, a semantic vector based on a query is referred to as “query vector”, and a semantic vector based on document data is referred to as “document vector”.

The similarity evaluation unit 123 evaluates similarity between a document vector (an example of first feature information) and a query vector (an example of second feature information), which are stored in the document vector storage unit 141 for each of multiple items of document data (an example of data). The document vector indicates a feature of the document data. The query vector indicates a feature of a query (an example of a first character string) designated in the input information. The evaluation of similarity between the query vector and the document vector is equivalent to the evaluation of similarity between the query and the document data. In one or more embodiments of the present disclosure, the term “evaluation” refers to the process of representing the evaluation target (here, similarity) by using a value corresponding to a predetermined index or measure (hereinafter referred to as “index”) (or refers to the process of calculating the value). In one or more embodiments of the present disclosure, the similarity indicates the degree to which the first feature information of the multiple items of document data described above is similar to the second feature information in the input information, and the evaluation index of similarity is referred to as “degree of similarity”.

The workspace collection unit 124 collects a workspace related to the query, based on the evaluation results of the similarity obtained by the similarity evaluation unit 123. The workspace related to the query is a workspace to which document data with relatively high similarity to the query belongs.

The variation evaluation unit 125 evaluates, for multiple workspaces (an example of multiple collections of data) to each of which one or more items of document data (an example of data) belong and which are collected by the workspace collection unit 124, states of variations in document vectors (an example of first feature information) of document data belonging to the workspaces (an example of multiple collections of data). In one or more embodiments of the present disclosure, the evaluation index of the state of variation is referred to as “degree of variation”.

The total evaluation unit 126 calculates a total evaluation value for each of the workspaces collected by the workspace collection unit 124. The total evaluation value is based on an evaluation result of similarity between the query vector and each document vector and an evaluation result of the state of variation and is hereinafter referred to as “total score”. The evaluation result of the state of variation is, for example, a result of application of the evaluation result of the state of variation in the document vector (an example of first feature information) to the variation evaluation criterion designated in the input information.

The display information generation unit 127 generates display information to be displayed on the user terminal 30. For example, the display information generation unit 127 generates display information of a screen on which workspaces (an example of multiple collections of data) collected by the workspace collection unit 124 are displayed in a mode based on the total scores calculated by the total evaluation unit 126. For example, when the display control unit 31 of the user terminal 30 is implemented by a web browser, a web page is an example of the display information. The display information may be generated in another format.

The output unit 128 outputs (transmits) the display information generated by the display information generation unit 127 to the user terminal 30.

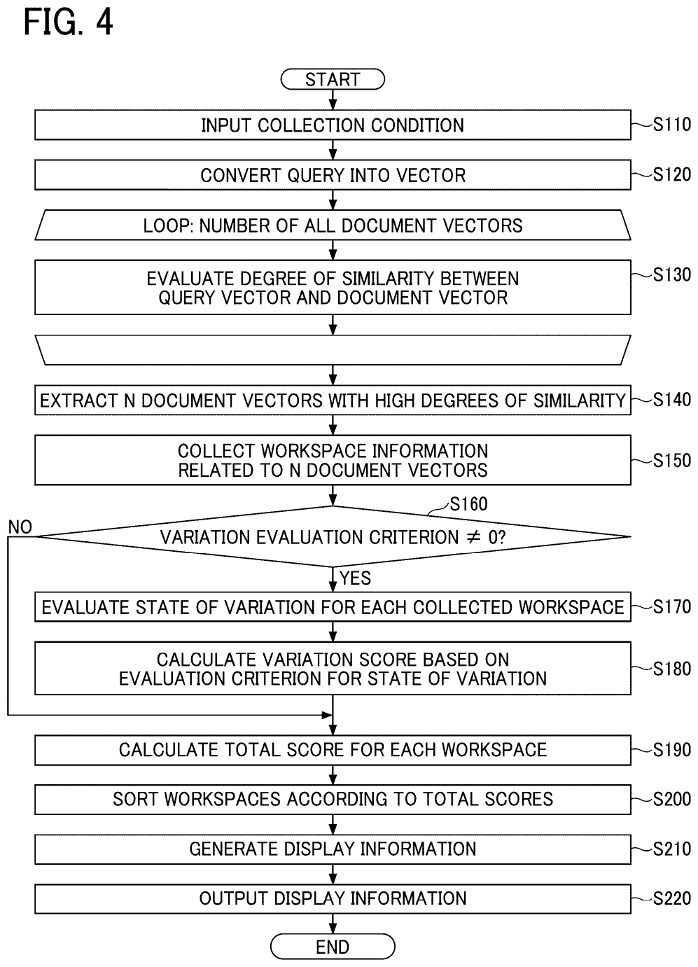

Procedures performed by the information processing system will be described hereinafter. FIG. 4 is a flowchart illustrating an example procedure of an information collection process according to the first embodiment.

In step S110, the display control unit 31 of the user terminal 30 accepts input of a collection condition from the user via a collection-condition input screen displayed on a display device of the user terminal 30.

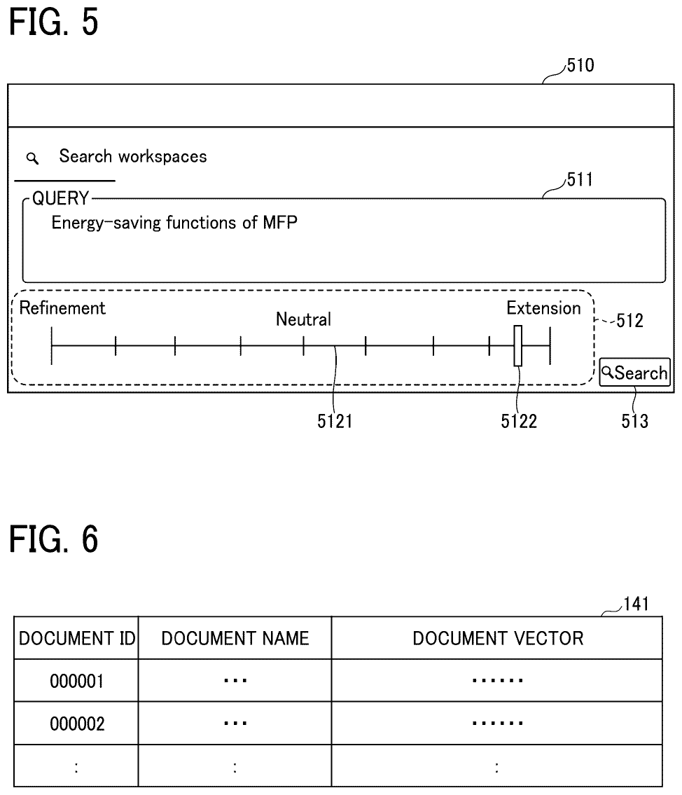

FIG. 5 illustrates an example of the collection-condition input screen according to the first embodiment. As illustrated in FIG. 5, a collection-condition input screen 510 includes, for example, a query input area 511, a variation evaluation criterion designation area 512, and a search button 513.

The query input area 511 is an area for accepting input of a query. The query may be input by using a keyboard or any other tool (including direct input from a touch panel) of the user terminal 30 or may be input by voice via a microphone of the user terminal 30.

The variation evaluation criterion designation area 512 is an area for accepting designation of a variation evaluation criterion, and includes a gauge 5121 and a slider 5122. The gauge 5121 indicates the range and direction of variation evaluation criteria. In FIG. 5, the gauge 5121 indicates “extension” of variation evaluation criteria to the right and “refinement” of variation evaluation criteria to the left, with a “neutral” variation evaluation criterion at the center. The slider 5122 is horizontally movable along the gauge 5121. The slider 5122 is a display component for accepting designation of a position on the gauge 5121 (i.e., designation of an evaluation criterion for a variation).

The “refinement” indicates evaluation criteria for preferentially searching for a workspace semantically specialized for the query (a workspace with a small semantic variation of the document data belonging to the workspace). The “extension” indicates evaluation criteria for preferentially searching for a workspace semantically broadened for the query (a workspace with a large semantic variation of the document data belonging to the workspace). The “neutral” evaluation criterion is an evaluation criterion for making the state of variation of a workspace not affect the evaluation of the workspace. The total evaluation of a workspace is based on the similarity to the query and the state of variation. When the slider 5122 is closer to the “extension” side, an evaluation criterion is designated according to which the degree of evaluation is higher (or the weight is larger) for a large variation. When the slider 5122 is closer to the “refinement” side, an evaluation criterion is designated according to which the degree of high evaluation is higher (or the weight is larger) for a small variation.

The user who desires to search for a workspace in which a semantically wide range of information including peripheral information for a specific instance is compiled moves the slider 5122 to the “extension” side. The user who desires to search for a workspace in which detailed information specialized for specific information is compiled moves the slider 5122 to the “refinement” side. As a result, the desired workspace is likely to be displayed at a high position in the search results.

In the present embodiment, the range of the variation evaluation criteria is set to −5 to +5. The “refinement” side is set to negative, and the “extension” side is set to positive, with “Neutral” set to 0. It is assumed that the larger the absolute value of the variation evaluation criterion to be designated, the closer the variation evaluation criterion is to the end in the direction indicated by the sign (negative or positive) of the variation evaluation criterion.

The search button 513 is a button for accepting an instruction to execute information collection (execute a search).

The collection-condition input screen 510 may be displayed on the user terminal 30 in response to, for example, a login of the user to the information collection apparatus 10.

After a query is input to the query input area 511 and a variation evaluation criterion is designated in the variation evaluation criterion designation area 512, the user presses the search button 513. In response to the user pressing the search button 513, the display control unit 31 transmits an information collection request including the input query and the designated variation evaluation criterion as information collection conditions to the information collection apparatus 10.

In response to the acceptance unit 121 of the information collection apparatus 10 receiving the information collection request, the vector conversion unit 122 converts the query (hereinafter referred to as “target query”) included in the information collection request (hereinafter referred to as “target collection request”) into a semantic vector (query vector) (S120).

Then, the similarity evaluation unit 123 compares, for each of the items of document data managed by the information management apparatus 20, the query vector and the document vector of the document data and calculates the degree of similarity between the query vector and the document vector (S130). The document vectors corresponding to the items of document data managed by the information management apparatus 20 are stored in the document vector storage unit 141.

FIG. 6 illustrates an example configuration of the document vector storage unit 141. As illustrated in FIG. 6, the document vector storage unit 141 stores a document ID, a document name, and a document vector for each item of document data. The document ID is identification information of document information related to the document data, and associates the document information in the information management apparatus 20 with a document vector in the document vector storage unit 141. The document name is the name or title of the document data. For example, when the document data is stored in a file format, the file name may be used as the document name. As described above, the document vector is a semantic vector indicating a semantic feature of the content of the document data.

In one embodiment, the degree of similarity between a query vector and a document vector is calculated by using the angle (cosine similarity) or the distance between the query vector and the document vector, as in the calculation of a degree of similarity between general vectors. In one embodiment, the cosine similarity is used. The cosine similarity between vectors a and b is calculated in accordance with the following formula.

$$cos ( a , b ) = \frac{a \cdot b}{‖ a ‖ ‖ b ‖}$$

After the degrees of similarity between the query vector and all of the document vectors are calculated, the similarity evaluation unit 123 extracts N document vectors with high degrees of similarity (S140). That is, N document vectors are extracted in descending order, starting from the one with the highest similarity to the query vector. The value N is an integer greater than or equal to 1 and is set in advance. In another example, a threshold may be set for the degree of similarity, and the number of document vectors for which the degrees of similarity are greater than or equal to the threshold may be N.

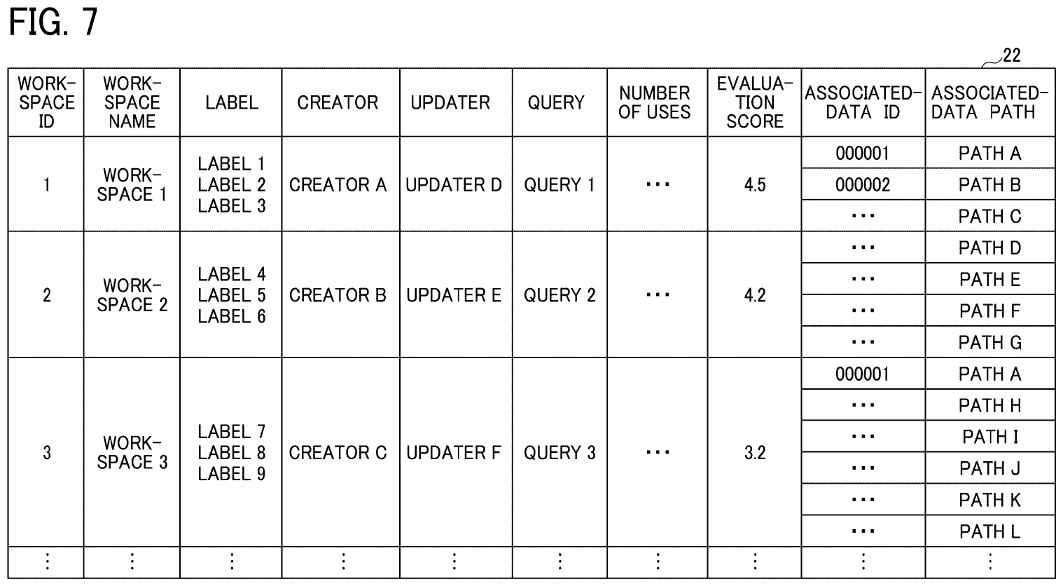

Then, the workspace collection unit 124 collects, for each of items of document information (document data) related to the N document vectors, a workspace related to the document information from the workspace storage unit 22 (FIG. 7) (S150).

FIG. 7 illustrates an example configuration of the workspace storage unit 22. As illustrated in FIG. 7, the workspace storage unit 22 stores, for each workspace, for example, a workspace ID, a workspace name, a label, a creator, an updater, a query, the number of uses, an evaluation score, an associated-data ID, and an associated-data path.

The workspace ID is identification information of a workspace. The workspace name is the name of the workspace. The label is a word of relatively importance among the words included in the document data belonging to the workspace. The relative importance is determined using, for example, term frequency-inverse document frequency (TF-IDF). The creator is identification information (such as a user ID or a user name) of a person who has created the workspace. The updater is identification information (such as a user ID or a user name) of a person who has updated the workspace. The query is a query input to collect document information from which the workspace is generated. Accordingly, the query is also referred to as information indicating a viewpoint or intention under which the workspace is collected as a collection of document information. The number of uses is the number of times the workspace has been used (referred to). The evaluation score is the value of an evaluation, which is input by a user who has referred to the workspace. The evaluation score is, for example, the average value of numerical values obtained in a five-step evaluation. The associated-data ID is a document ID of each item of document information belonging to the workspace. The associated-data path is a file path of the document data of each item of document information.

The identification information of a workspace related to certain document information indicates a workspace including the document ID of the certain document information as an associated-data ID. In one example, multiple workspaces may be related to the same item of document information. In another example, one workspace may be related to multiple items of document information. If the number of workspaces associated with the items of document information related to the N document vectors with high degrees of similarity exceeds a threshold M (i.e., if the number of workspaces is too large), not all of the collected workspaces but M workspaces may be subjected to the processing of step S160 and the subsequent processing. The M workspaces may be extracted from among the collected workspaces in descending order, starting from the one for which the degree of similarity to the target query is highest.

The degree of similarity between a certain workspace and the target query is an average or a maximum value of the degrees of similarity between the query vector of the target query and document vectors related to the items of document data belonging to the certain workspace. In another embodiment, the degree of similarity between a certain workspace and the target query is an average of the degrees of similarity between the query vector of the target query and N document vectors with high degrees of similarity among document vectors related to the items of document data belonging to the certain workspace.

Then, the variation evaluation unit 125 determines whether the value of the variation evaluation criterion included in the target collection request is non-zero (S160). The variation evaluation criterion included in the target collection request is hereinafter referred to as “target variation evaluation criterion”. If the value of the target variation evaluation criterion is non-zero (Yes in S160), the variation evaluation unit 125 evaluates, for each of the collected workspaces, the state of variation of the workspace (S170). The state of variation of a certain workspace refers to the state of variation (i.e., semantic variance) of a document vector group related to the document data group belonging to the certain workspace.

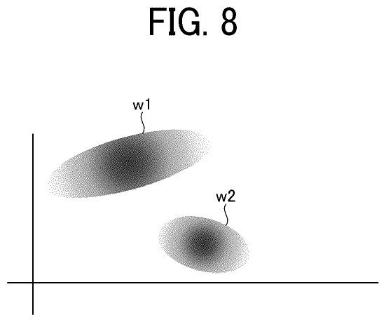

FIG. 8 illustrates an image of states of variations of respective workspaces. In the image illustrated in FIG. 8, document vectors belonging to a workspace w1 and document vectors belonging to a workspace w2 are plotted as points in a space corresponding to a semantic vector. The space is hereinafter referred to as “semantic space”. In FIG. 8, the semantic space is represented in two dimensions for convenience of description. The semantic space has the same number of dimensions (e.g., 1024) as the number of dimensions of the semantic vector.

The example illustrated in FIG. 8 indicates that the workspace w1 has a larger variation than the workspace w2. A workspace with a large variation can be a workspace including various information (i.e., having a large amount of information). A workspace with a small variation can be a workspace including information specialized for a certain meaning.

Since document vectors are multidimensional, it is difficult to calculate a variance, which is a representative index of the state of variation. Accordingly, the variation evaluation unit 125 uses principal component analysis to evaluate the state of variation of each workspace. The variation evaluation unit 125 evaluates the state of variation, based on a contribution rate of each principal component obtained from principal component analysis of document vectors (an example of first feature information) of document data (an example of data) belonging to a workspace (an example of a collection of data) and a threshold for a cumulative value of high contribution rates among the contribution rates.

In one embodiment, principal component analysis of a certain workspace is obtained using, for example, eigenvalues and eigenvectors of a variance-covariance matrix of a document vector group belonging to the certain workspace. In other words, among multiple sets of eigenvectors and eigenvalues obtained for a certain workspace, the eigenvector in each set is a principal component vector (hereinafter simply referred to as “principal component”), and the ratio of the eigenvalue in each set to the sum of the eigenvalues in the sets indicates the contribution rate of the principal component in the set.

The variation evaluation unit 125 sorts the principal components of each workspace in descending order of the contribution rates, and sets, as the degree of variation of the workspace, the number of principal components for which a cumulative value of high contribution rates reaches a cumulative contribution rate set as a threshold in advance. The smaller the value of the degree of variation, the smaller the variation, and the larger the value of the degree of variation, the larger the variation.

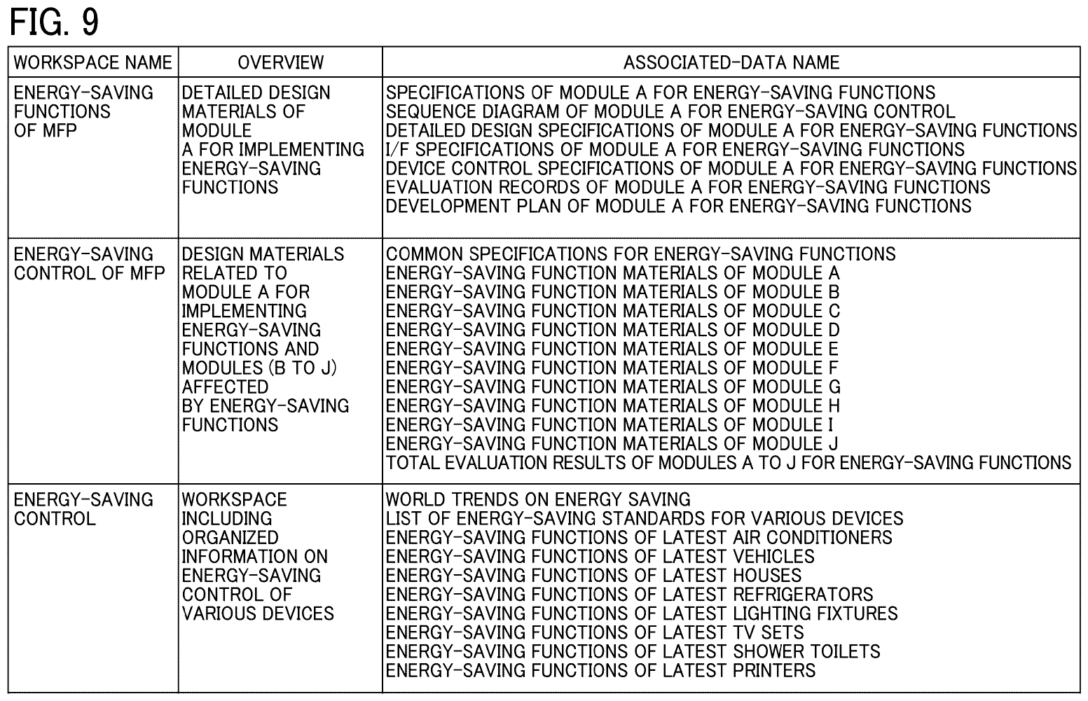

A specific example will be described. It is assumed that two workspaces described below are collected. FIG. 9 illustrates an example of workspaces to describe a method for calculating a degree of variation of a workspace. In FIG. 9, an associated-data name represents the document name (FIG. 6) corresponding to the associated-data ID (FIG. 7).

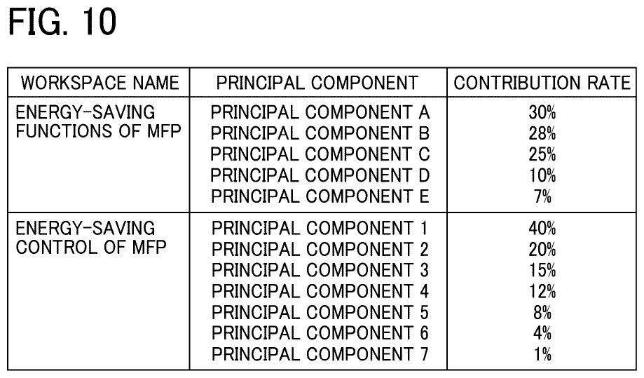

Two of the three workspaces illustrated in FIG. 9 are subjected to principal component analysis, and results of the principal component analysis are illustrated in FIG. 10. FIG. 10 illustrates an example of results of principal component analysis of the workspaces.

In the example illustrated in FIG. 10, principal components A to E are obtained for a first workspace (the workspace “energy-saving functions of MFP”) and principal components 1 to 7 are obtained for a second workspace (the workspace “energy-saving control of MFP”). MFP stands for multifunction peripheral. FIG. 10 also illustrates the contribution rates of the respective principal components, and the principal components are sorted in the descending order of the contribution rates. In FIG. 10, results of principal component analysis of a third workspace (the workspace “energy-saving control”) illustrated in FIG. 9 are omitted for convenience.

It is assumed that a cumulative contribution rate of 80% is set as a threshold in advance.

In the workspace “energy-saving functions of MFP”, the sum of the contribution rates of the principal components A, B, and C is greater than or equal to 80%.

$$30 \% + 28 \% + 25 \% = 83 \% \geq 80 \%$$

The variation evaluation unit 125 calculates the ratio of the value obtained by subtracting the sum of the top two contribution rates from the cumulative contribution rate to the third highest contribution rate.

$$( 80 \% - ( 30 \% + 28 \% ) ) \div 25 \% = 22 \% \div 25 \% = 0.88$$

In this case, the sum of the contribution rates of the two principal components and 88% of the contribution rate of the third principal component is calculated. As a result, the cumulative value of several high contribution rates matches the cumulative contribution rate serving as the threshold. Accordingly, the variation evaluation unit 125 calculates the degree of variation of the workspace “energy-saving functions of MFP” to be 2.88.

Likewise, in the workspace “energy-saving control of MFP”, the sum of the contribution rates of the principal components 1, 2, 3, and 4 is greater than or equal to 80%.

$$40 \% + 20 \% + 15 \% + 12 \% = 87 \% \geq 80 \%$$

The variation evaluation unit 125 calculates the ratio of the value obtained by subtracting the sum of the top three contribution rates from the cumulative contribution rate to the fourth highest contribution rate.

$$( 80 \% - ( 40 \% + 20 \% + 15 \% ) ) \div 12 \% = 5 \% \div 12 \% = 0.42$$

In this case, the sum of the contribution rates of the three principal components and 42% of the contribution rate of the fourth principal component is calculated. As a result, the cumulative value of several high contribution rates matches the cumulative contribution rate serving as the threshold. Accordingly, the variation evaluation unit 125 calculates the degree of variation of the workspace “energy-saving control of MFP” to be 3.42.

In the example illustrated in FIG. 10, the evaluation results indicate that the workspace “energy-saving functions of MFP” has a smaller variation and the workspace “energy-saving control of MFP” has a larger variation.

In one embodiment, the cumulative contribution rate serving as the threshold is set in the range of 0 to 100(%). Since 0 and 100 are substantially meaningless, three options such as {30, 60, 90} or five options such as {10, 30, 50, 70, 90} may be presented to the user to select a threshold.

In one example, the variation evaluation unit 125 calculates the degree of variation of each of the workspaces stored in the workspace storage unit 22 at a time unrelated to the procedure illustrated in FIG. 4. Examples of the time unrelated to the process illustrated in FIG. 4 include the time at which the workspace is registered in the workspace storage unit 22, the time at which the workspace is updated, and a periodic time. The variation evaluation unit 125 stores the calculated degree of variation in, for example, the auxiliary storage device 102 in association with the workspace ID of the workspace. In this case, in step S170, the variation evaluation unit 125 may acquire a degree of variation stored in advance for each of the collected workspaces.

Then, the variation evaluation unit 125 converts, for each of the collected workspaces, the degree of variation of the workspace into a variation score in accordance with the target variation evaluation criterion (S180). The variation score is an index indicating the degree of suitability for the variation direction (i.e., refinement or extension) designated in the target variation evaluation criterion. Accordingly, in one example, the variation score has a larger value for a larger degree of variation when the sign of the target variation evaluation criterion is positive (toward “extension”), and has a larger value for a smaller degree of variation when the sign of the target variation evaluation criterion is negative (toward “refinement”). For example, when the sign of the target variation evaluation criterion is positive, the values of the ranks assigned to the degrees of variations in ascending order may be used as the variation scores of the respective workspaces. In another embodiment, differences between the degrees of variations of the respective workspaces may be reflected in the variation scores of the respective workspaces. When the sign of the target variation evaluation criterion is negative, the values of the ranks assigned to the degrees of variations in descending order may be used as the variation scores of the respective workspaces. In another embodiment, differences between the degrees of variations of the respective workspaces may be reflected in the variation scores of the respective workspaces.

If the value of the target variation evaluation criterion is 0 (No in S160), the variation evaluation unit 125 skips the processing of steps S170 and S180.

After step S180 or if No is obtained in step S160, the total evaluation unit 126 calculates a total score for each of the collected workspaces (S190). The total score is the overall evaluation value of each workspace and is based on the degree of similarity to the target query and the variation score of the workspace. When the degree of similarity between a certain workspace and the target query is x and the variation score of the certain workspace is y, for example, the total score of the certain workspace may be calculated in the following way.

$$Total score = {x}^{′} + α \times {y}^{′} ,$$

where x′ and y′ are normalized values of x and y, respectively, to make the scales (the range from the minimum value to the maximum value) of x and y match, and a is the absolute value of the target variation evaluation criterion.

Then, the total evaluation unit 126 sorts the workspaces in descending order of the total scores (S200).

If the number of collected workspaces is greater than the threshold M, the total evaluation unit 126 may extract the top M workspaces according to the total scores. In this example, only the extracted workspaces may be targets to be subjected to the processing of the subsequent steps.

Then, the display information generation unit 127 generates display information of a screen for displaying the sorted results as the results of the collected workspaces (S210). The screen is hereinafter referred to as “search result screen”.

Then, the output unit 128 transmits the display information to the user terminal 30 (S220). The display control unit 31 of the user terminal 30 displays the search result screen based on the display information.

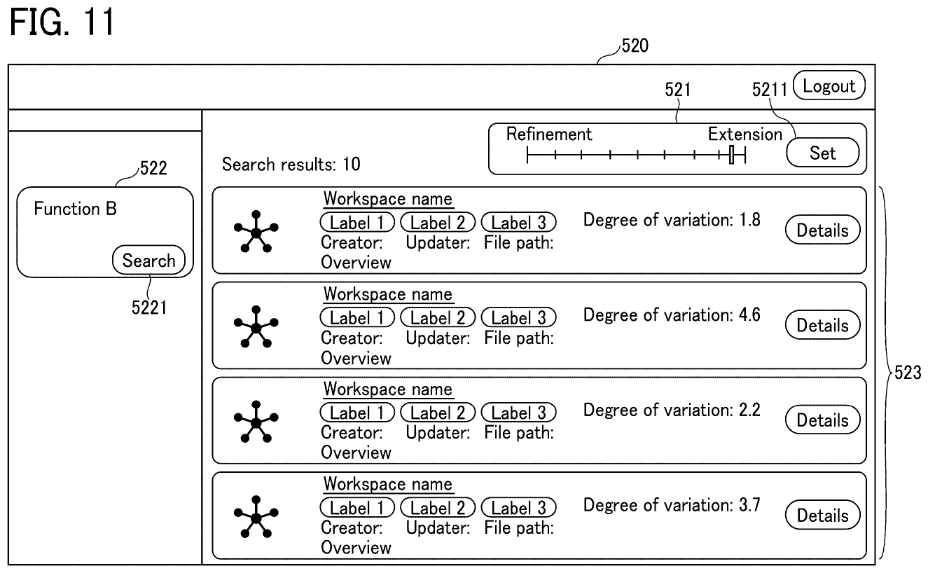

FIG. 11 illustrates a first example of the displayed search result screen. As illustrated in FIG. 11, a search result screen 520 includes a variation evaluation criterion display area 521, a query display area 522, and search result display areas 523.

The variation evaluation criterion display area 521 is an area for displaying the target variation evaluation criterion. The query display area 522 is an area for displaying the target query. The search result display areas 523 are areas for displaying a list of workspaces sorted according to the total scores. Each of the search result display areas 523 includes, for example, a numerical value indicating the degree of variation of a corresponding one of the workspaces included in the list.

In one embodiment, the user refers to the search result screen 520 and checks a list of workspaces collected under a collection condition.

For example, the workspaces illustrated in FIG. 9 are registered in the workspace storage unit 22. The workspace “energy-saving functions of MFP” is a workspace including detailed information (document data) related to module A among energy-saving functions. The workspace “energy-saving control of MFP” is a workspace including the entire specifications of modules A to J that implement the energy-saving functions, and document data indicating the design of each of the modules A to J according to the entire specifications. The workspace “energy-saving control” is a workspace including organized information (document data) on the energy-saving functions of household electrical appliances and devices other than MFPs.

In one example, a new function is to be added to the energy-saving functions of an MFP. In this case, the influence of the addition of the new function on the entire MFP, such as which module is to be affected by the addition of the new function, is preferably examined by referring to the workspace “energy-saving control of MFP”. By contrast, the detailed influence of the addition of the new function on the module A is preferably examined by referring to the workspace “energy-saving functions of MFP”.

In a case where the target query is the “energy-saving functions of MFP”, the degrees of similarity of the workspaces “energy-saving functions of MFP” and “energy-saving control of MFP” to the target query are likely to be substantially the same. The user examines each of the workspaces to find a desired workspace.

In the present embodiment, accordingly, the user is allowed to designate a variation evaluation criterion.

In one example, document data related to the energy saving of various devices is registered in the information management apparatus 20. In this case, the user designates the query “energy-saving functions of MFP” and a variation evaluation criterion on the “refinement” side. As a result, the workspace “energy-saving functions of MFP” is obtained as a high search result ranking.

In another example, the user designates the query “energy-saving functions of MFP” and a variation evaluation criterion on the “extension” side. As a result, the workspace “energy-saving control of MFP” is obtained as a high search result ranking.

In another example, the user designates the query “energy-saving control” and a variation evaluation criterion on the “extension” side. As a result, the workspace “energy-saving control” is obtained as a high search result ranking.

Refinement may typically be implemented by a method of adding a keyword to the keyword(s) included in the query. For example, the query is designated as “energy-saving functions of MFP” and “module A”. By contrast, a search toward “extension” is difficult to implement by adding a keyword because the content to which the search is extended is difficult to specifically identify. This is because, in response to a vague request such as a request for examining all of the information related to the query, it is difficult for the user to grasp in advance a keyword to be added for designation.

In one embodiment, the user uses the variation evaluation criterion display area 521 illustrated in FIG. 11 to change the variation evaluation criterion.

For example, in the variation evaluation criterion display area 521, a variation evaluation criterion is designated by an operation similar to the operation described with reference to FIG. 5, and then a button 5211 is pressed. In response to the pressing of the button 5211, the display control unit 31 of the user terminal 30 transmits the variation evaluation criterion (the variation evaluation criterion after the change) designated in the variation evaluation criterion display area 521 to the information collection apparatus 10. In response to the acceptance unit 121 of the information collection apparatus 10 receiving the variation evaluation criterion, the processing of step S160 and the subsequent processing in FIG. 4 are performed again in accordance with the received variation evaluation criterion. In this case, the variation scores of the workspaces are changed. As a result, the search result display areas 523 of the search result screen 520 display different sorted results for the same collection of workspaces. Specifically, in response to a variation evaluation criterion being changed after the display information of the search result screen 520 (FIG. 11) is generated, the display information generation unit 127 generates display information of the search result screen 520 to display the workspaces (an example of a collection of data) in a mode based on the evaluation results of the similarity and the results obtained by application of the states of variations of the document vectors (an example of first feature information) to a new variation evaluation criterion obtained as a result of the change. Accordingly, in one embodiment, the user searches for a desired workspace while adjusting variation evaluation criteria.

A new query is input to the query display area 522, and a button 5221 is pressed. In response to the pressing of the button 5221, the display control unit 31 transmits an information collection request including the new query and the variation evaluation criterion designated in the variation evaluation criterion display area 521 to the information collection apparatus 10. In this case, the processing of step S110 and the subsequent processing in FIG. 4 are performed again, and the search result screen 520 including new search results is displayed on the user terminal 30.

The search result display areas 523 illustrated in FIG. 11 indicate the numerical values of the degrees of variations of the respective workspaces. The display information generation unit 127 may generate display information of the search result screen 520 such that the states of variations (the magnitudes of the degrees of variations) are represented by another method.

For example, the workspace names of the respective workspaces may be displayed in colors corresponding to the degrees of variations of the workspaces. The workspace names of the respective workspaces may be displayed such that, for example, the color of the workspace name of a workspace name with a smaller degree of variation is closer to red and the color of the workspace name of a workspace with a larger degree of variation is closer to blue.

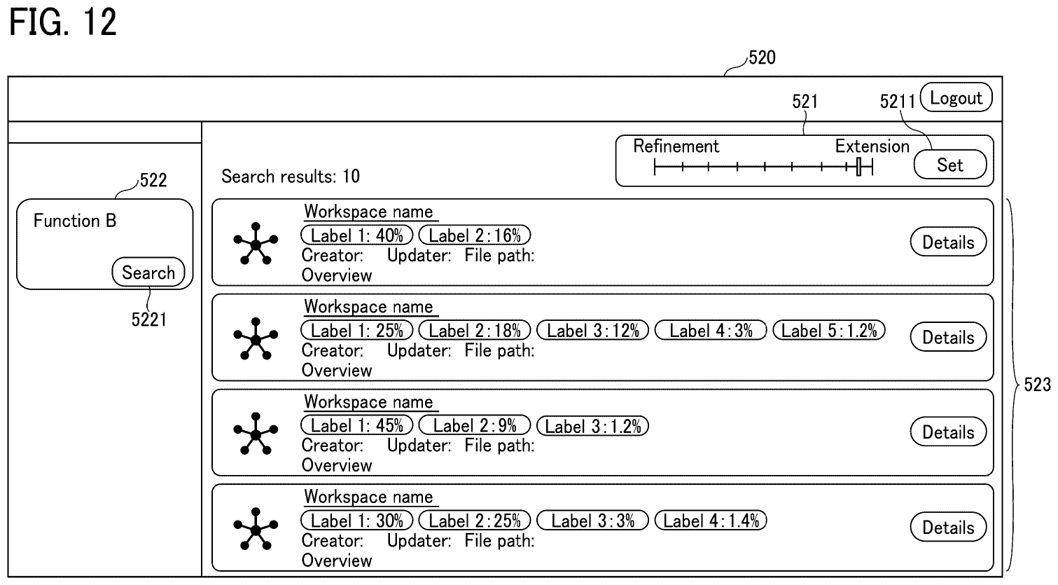

FIG. 12 illustrates a second example of the displayed search result screen. Each of the search result display areas 523 illustrated in FIG. 12 includes, for a corresponding one of the workspaces, a label and a contribution rate corresponding to each principal component. For example, words may be extracted using TF-IDF from among words included in document data belonging to a certain workspace. Of the extracted words, a word for which the degree of similarity between the semantic vector and a certain principal component is smallest may be used as the label of the certain principal component.

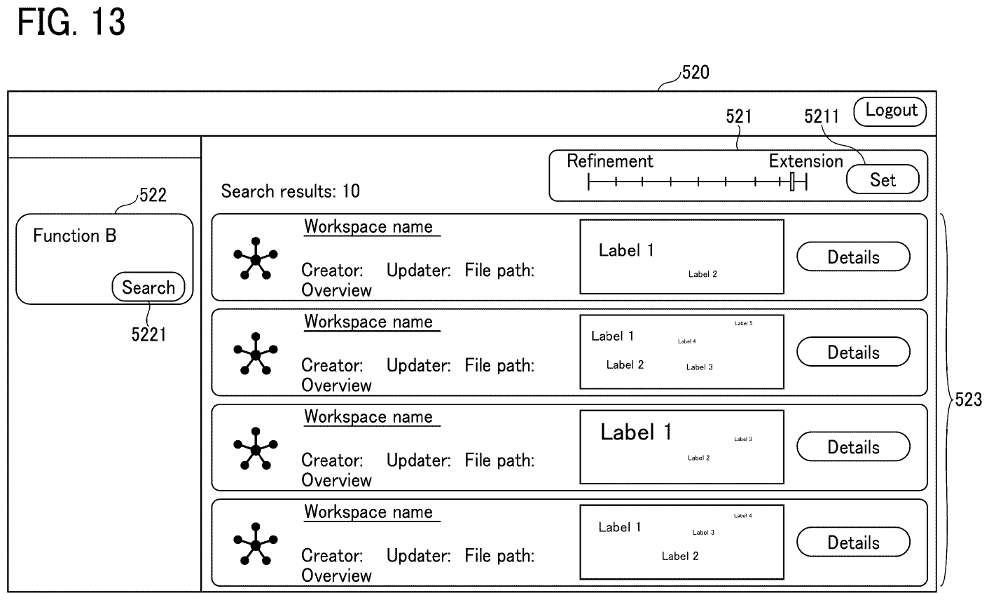

FIG. 13 illustrates a third example of the displayed search result screen. In each of the search result display areas 523 illustrated in FIG. 13, for a corresponding one of the workspaces, the labels of the principal components are arranged in a format such as a word cloud format to represent the variation of the workspace.

As described above, the first embodiment enables display of results of collected workspaces (collections of document data) based on a query such that, in response to designation of a variation evaluation criterion, a workspace with a small semantic variation of the document data is preferentially displayed (in a high-ranking position) or a workspace with a large semantic variation of the document data is preferentially displayed (in a high-ranking position). For example, the user who desires to collect workspaces specialized for a query or desires to collect workspaces including information related to a query and peripheral information related to the query adjusts variation evaluation criteria in accordance with the desire of the user, thereby making it more likely that desired collection results (search results) are obtained. As a result, it is possible to improve the convenience of information collection.

Each workspace is a collection of data compiled from the viewpoint of the creator of the workspace. Thus, a workspace related to a “function B of a theme A” may have different granularities, such as a workspace in which details of the function B are compiled and a workspace in which peripheral functions related to the function B are compiled. The present embodiment enables a workspace that matches the purpose of the user in terms of information density to be preferentially retrieved, thereby further improving the convenience for the user to collect information.

Next, a second embodiment will be described. In the second embodiment, differences from the first embodiment will be described. Accordingly, the second embodiment may be similar to the first embodiment unless otherwise specified.

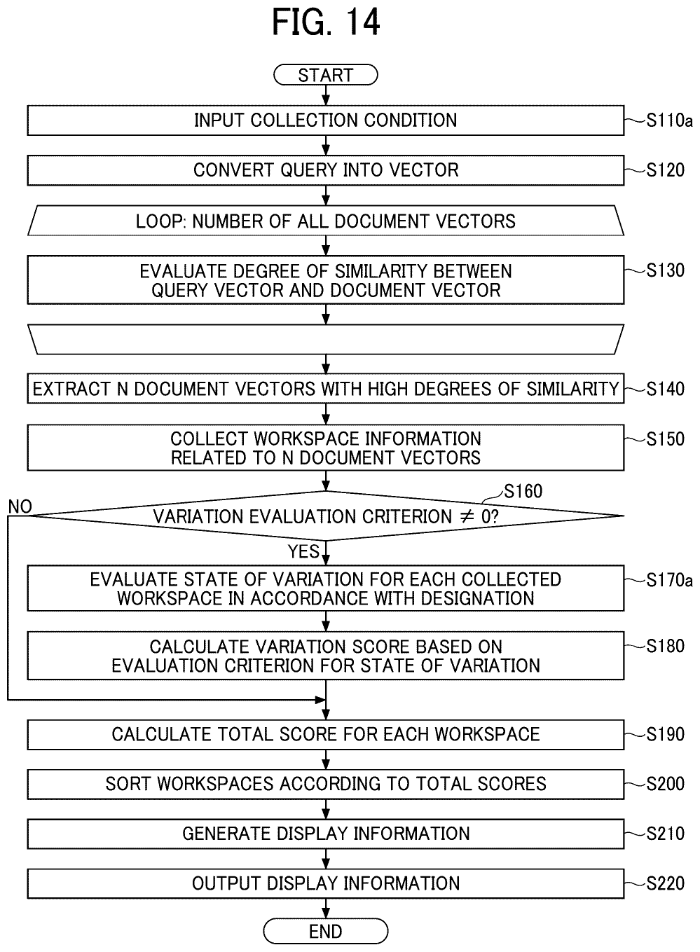

FIG. 14 is a flowchart illustrating an example procedure of an information collection process according to the second embodiment. In FIG. 14, the same steps as those in FIG. 4 are denoted by the same step numerals, and descriptions thereof will be omitted. In FIG. 14, steps S110 and S170 in FIG. 4 are replaced with steps S110a and S170a, respectively.

In step S110a, the display control unit 31 of the user terminal 30 accepts input of a collection condition from the user via a collection-condition input screen displayed on the display device of the user terminal 30. In the second embodiment, the collection-condition input screen has a different configuration from that in the first embodiment (FIG. 5).

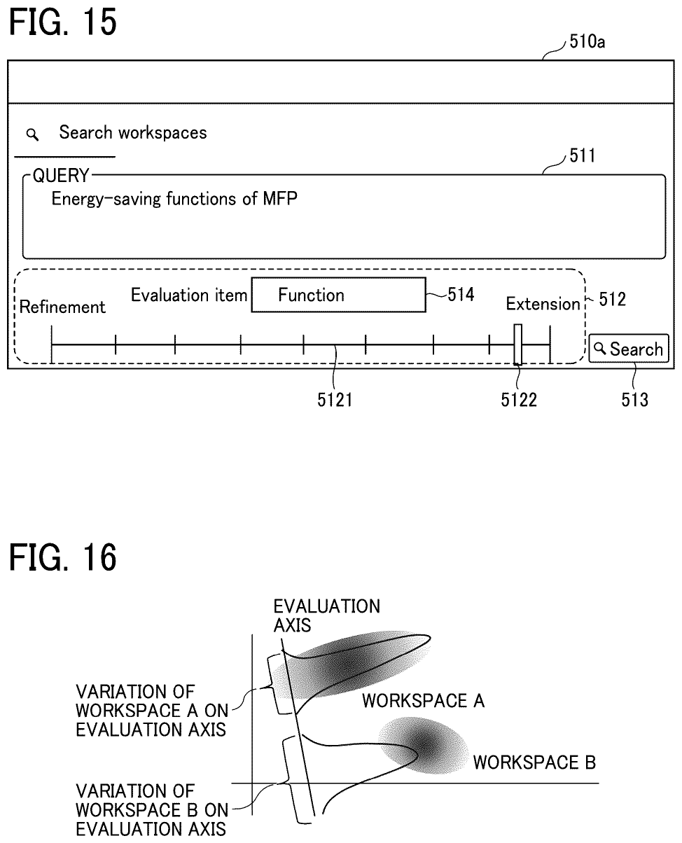

FIG. 15 illustrates an example of the collection-condition input screen according to the second embodiment. In FIG. 15, the same portions as those in FIG. 5 are denoted by the same reference numerals, and descriptions thereof will be omitted.

A collection-condition input screen 510a illustrated in FIG. 15 further includes an evaluation item designation area 514. The evaluation item designation area 514 is an area for accepting input (designation) of a character string indicating an item (meaning) for which the states of variations of the workspaces are to be evaluated. The character string is hereinafter referred to as “evaluation item”. In FIG. 15, as an example, the character string “function” is input in the evaluation item designation area 514. Examples of the evaluation item to be input include a word and any character string (such as a sentence).

In response to the user pressing the search button 513, the display control unit 31 transmits an information collection request including an information collection condition to the information collection apparatus 10. Specifically, the information collection request includes the input query (i.e., the target query), the designated variation evaluation criterion (i.e., the target variation evaluation criterion), and the input evaluation item (an example of a second character string). The input evaluation item is hereinafter referred to as “target evaluation item”.

In step S170a, the variation evaluation unit 125 evaluates, for each of the collected workspaces, the state of variation in accordance with the designation. The evaluation of the state of variation in accordance with the designation means that the state of variation is evaluated in a manner similar to that in the first embodiment when no evaluation item is input. In a case where a target evaluation item (an example of a second character string) is input, the evaluation of the state of variation in accordance with the designation means that the state of variation for the feature of the target evaluation item (an example of a second character string) is evaluated for the document vectors (an example of first feature information) belonging to each workspace. The state of variation for the feature of the target evaluation item refers to the state of variation on an axis corresponding to the semantic vector of the target evaluation item. The axis is hereinafter referred to as “evaluation axis”.

FIG. 16 illustrates an evaluation of the states of variations of workspaces on the evaluation axis. In FIG. 16, as in FIG. 8, a semantic space is represented in two dimensions, for convenience.

The evaluation axis is an axis corresponding to the semantic vector of an evaluation item in the semantic space. The state of variation of a workspace on the evaluation axis refers to the state of semantic variation (related to an evaluation item) of document data belonging to the workspace on the evaluation axis. The variation evaluation unit 125 calculates a variance of scalar values, which is obtained by projecting the document vectors of the document data onto a one-dimensional evaluation axis, to evaluate the state of variation of the workspace on the evaluation axis. That is, in the second embodiment, the value of the variance is the degree of variation.

After step S180, a process similar to that in the first embodiment is executed by using the degrees of variations calculated in step S170a.

As described above, the second embodiment enables evaluation of the states of variations of workspaces in a specific meaning (space), and the display mode of the results of the collected workspaces can be changed based on the result of the evaluation.

Next, a third embodiment will be described. In the third embodiment, differences from the second embodiment will be described. Accordingly, the third embodiment may be similar to the second embodiment unless otherwise specified.

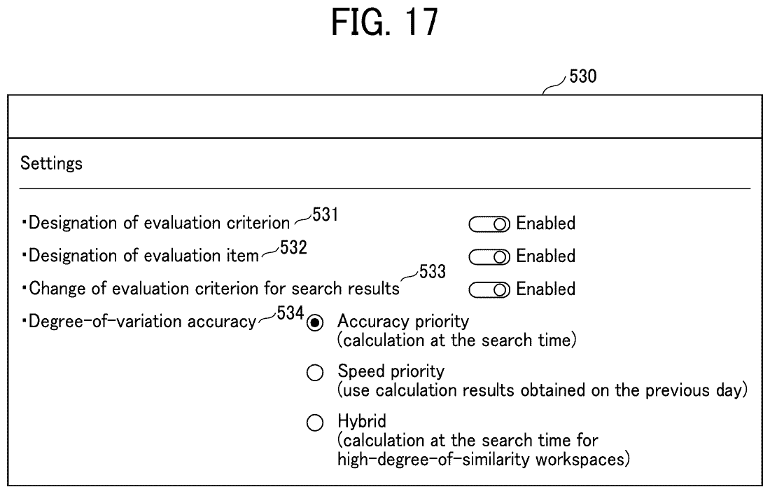

In the third embodiment, setting information is set in advance for a method for evaluating the states of variations. The setting information is set by the user through, for example, a setting screen illustrated in FIG. 17.

FIG. 17 illustrates an example of the setting screen according to the third embodiment. As illustrated in FIG. 17, a setting screen 530 includes setting areas 531 to 534.

The setting area 531 is an area for accepting a setting as to whether to enable the variation evaluation criterion designated in the variation evaluation criterion designation area 512 of the collection-condition input screen 510a (FIG. 15). The setting is hereinafter referred to as “evaluation criterion designation setting”. When “Enabled” is not selected in the setting area 531, for example, the variation evaluation criterion designation area 512 is grayed out and inoperable. In another example, the variation evaluation criterion designation area 512 is operable, but the designation of a variation evaluation criterion is disabled.

The setting area 532 is an area for receiving a setting as to whether to enable the designation of an evaluation item in the evaluation item designation area 514 of the collection-condition input screen 510a (FIG. 15). The setting is hereinafter referred to as “evaluation item designation setting”. When “Enabled” is not selected in the setting area 532, for example, the evaluation item designation area 514 is grayed out and inoperable. In another example, the evaluation item designation area 514 is operable, but the designation of an evaluation item is disabled.

The setting area 533 is an area for accepting a setting as to whether to enable a change of the variation evaluation criterion in the variation evaluation criterion display area 521 of the search result screen 520 (FIG. 11). The setting is hereinafter referred to as “evaluation criterion change setting”. When “Enabled” is not selected in the setting area 533, for example, the variation evaluation criterion display area 521 is grayed out and inoperable. In another example, the variation evaluation criterion display area 521 is operable, but the designation of a variation evaluation criterion is disabled.

The setting area 534 is an area for accepting a setting related to the accuracy of the degrees of variations. The setting is hereinafter referred to as “degree-of-variation accuracy setting”. The setting area 534 provides options “accuracy priority”, “speed priority”, and “hybrid”. The option “accuracy priority” indicates that the current degrees of variations of all the workspaces collected in step S150 are calculated. The option “speed priority” indicates that the degrees of variations (the degrees of variation in the first embodiment) of all the workspaces are calculated in a batch manner periodically (e.g., every day at night) (i.e., before input information is input) and, in response to receipt of an information collection request, the calculation results obtained on the previous day are used. The option “hybrid” refers to a combination of the options “accuracy priority” and “speed priority”. Specifically, the option “hybrid” indicates that the current degrees of variations of workspaces having high degrees of similarity to the query among the workspaces collected in step S150 are calculated and, for the other workspaces, the calculation results obtained on the previous day are used. In other words, the degree-of-variation accuracy setting is also a setting as to whether to use evaluation results of the states of variations obtained after an information collection request is received or evaluation results of the states of variations obtained before an information collection request is received. Each workspace is editable (by, for example, adding or deleting document data). Thus, the degree of variation of each workspace may change over time.

The results of the settings on the setting screen 530 are stored in, for example, the auxiliary storage device 102.

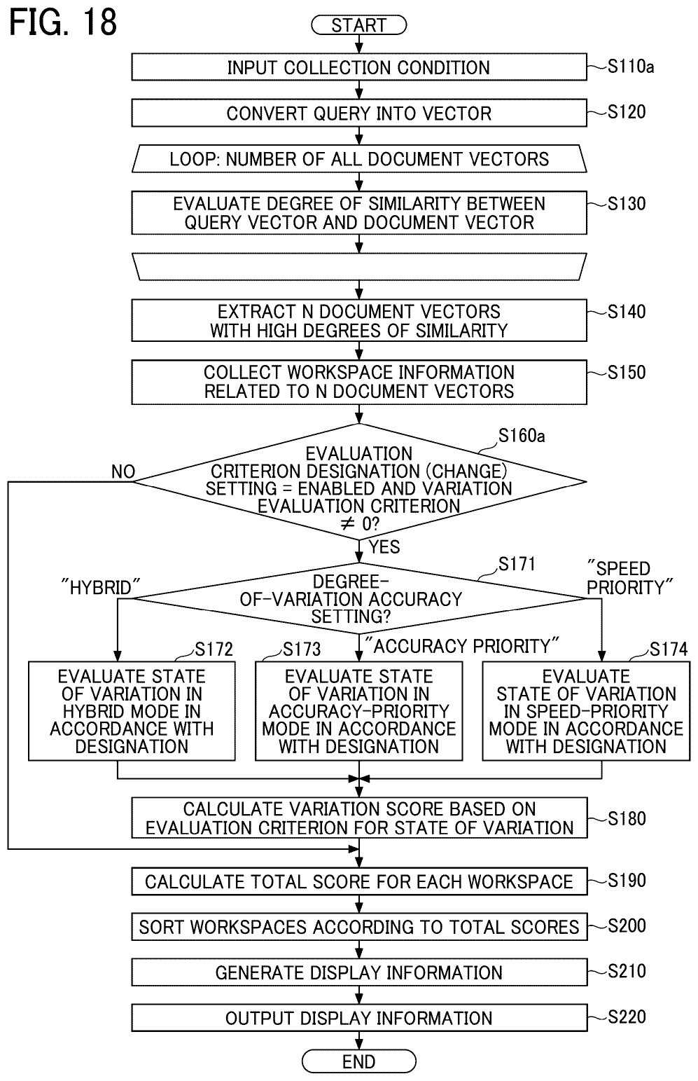

FIG. 18 is a flowchart illustrating an example procedure of an information collection process according to the third embodiment. In FIG. 18, the same steps as those in FIG. 14 are denoted by the same step numerals, and descriptions thereof will be omitted. In FIG. 18, step S160 in FIG. 14 is replaced with step S160a, and step S170a in FIG. 14 is replaced with steps S171 to S174.

In step S160a, the variation evaluation unit 125 determines whether two conditions are satisfied (S160). Specifically, the variation evaluation unit 125 determines whether the evaluation criterion designation setting or the evaluation criterion change setting is “enabled” (condition 1) and whether the value of the variation evaluation criterion included in the target collection request (i.e., the target variation evaluation criterion) is non-zero (condition 2). In one example, the processing of step S160a is executed in accordance with the operation of the collection-condition input screen 510a (FIG. 15). In this case, the condition 1 is a condition in which the evaluation criterion designation setting is “enabled”. In another example, the processing of step S160a is executed in accordance with the operation of the variation evaluation criterion display area 521 of the search result screen 520 (FIG. 11). In this case, the condition 1 is a condition in which the evaluation criterion change setting is “enabled”.

If at least one of the conditions 1 and 2 is not satisfied (No in S160a), the process proceeds to step S190. In this case, no evaluation is performed on the states of variations.

If both of the conditions 1 and 2 are satisfied (Yes in S160a), the variation evaluation unit 125 branches the process in accordance with the setting of the degree-of-variation accuracy setting (an example of preset information) (S171).

If the degree-of-variation accuracy setting is set to “hybrid” (“hybrid” in S171), the variation evaluation unit 125 evaluates the states of variations in a hybrid mode in accordance with the designation (S172). The evaluation of the states of variations in accordance with the designation refers to the evaluation of the states of variations in accordance with the evaluation item designated in the evaluation item designation setting and the evaluation item designation area 514 of the collection-condition input screen 510a (FIG. 15). The evaluation of the states of variations in the hybrid mode refers to the evaluation of the current states of variations of several workspaces (for example, M workspaces) having high degrees of similarity to the target query among the collected workspaces. The workspaces having high degrees of similarity to the target query is hereinafter referred to as “higher-ranked workspaces”. Accordingly, if the evaluation item designation setting is not “enabled” or if no evaluation item is designated (input), the variation evaluation unit 125 calculates the degrees of variations of the higher-ranked workspaces in a manner similar to that in step S170 in FIG. 4. Then, the variation evaluation unit 125 uses, for workspaces other than the higher-ranked workspaces among the collected workspaces, the degrees of variations calculated in the past (e.g., on the previous day) as evaluation results (results of evaluating the states of variations in response to input of the input information). The workspaces other than the higher-ranked workspaces are hereinafter referred to as “lower-ranked workspaces”. On the other hand, if the evaluation item designation setting is “enabled” and if an evaluation item is designated (input), the variation evaluation unit 125 calculates the degrees of variations of the higher-ranked workspaces in a manner similar to that in step S170a in FIG. 14, and sets the degrees of variations of the lower-ranked workspaces to zero. This is because the evaluation item is unknown in the periodic evaluation of the states of variations and thus the states of variations were difficult to evaluate in the past (e.g., on the previous day) in accordance with the evaluation item.

If the degree-of-variation accuracy setting is set to “accuracy priority” (“accuracy priority” in S171), the variation evaluation unit 125 evaluates the states of variations in an accuracy-priority mode in accordance with the designation (S173). The evaluation of the states of variations in accordance with the designation is as described in step S172. The evaluation of the states of variations in the accuracy-priority mode refers to the evaluation of the current states of variations of all the collected workspaces. Accordingly, if the evaluation item designation setting is not “enabled” or if no evaluation item is designated (input), the variation evaluation unit 125 calculates the degree of variation of each of the collected workspaces in a manner similar to that in step S170 in FIG. 4. On the other hand, if the evaluation item designation setting is “enabled” and if an evaluation item is designated (input), the variation evaluation unit 125 calculates the degree of variation of each of the collected workspaces in a manner similar to that in step S170a in FIG. 14.

If the degree-of-variation accuracy setting is set to “speed priority” (“speed priority” in S171), the variation evaluation unit 125 evaluates the states of variations in a speed-priority mode in accordance with the designation (S174). The evaluation of the states of variations in accordance with the designation is as described in step S172. The evaluation of the states of variations in the speed-priority mode indicates that the states of variations calculated in the past (e.g., on the previous day) for all the collected workspaces are used as evaluation results. Accordingly, if the evaluation item designation setting is not “enabled” or if no evaluation item is designated (input), the variation evaluation unit 125 uses, as an evaluation result, the degree of variation calculated in the past (e.g., on the previous day) for each of the collected workspaces. On the other hand, if the evaluation item designation setting is “enabled” and if an evaluation item is designated (input), the variation evaluation unit 125 calculates the degree of variation of each of the collected workspaces in a manner similar to that for the evaluation in the hybrid mode under the same conditions. In this case, accordingly, the degrees of variations of the lower-ranked workspaces are set to zero.

After step S172, S173, or S174, the process proceeds to step S180.

The variation evaluation unit 125 may use, as an evaluation result, the degree of variation calculated in the past (e.g., on the previous day) for a workspace for which the degree of variation calculated in the past is not changed, even when the current degree of variation of such a workspace is to be calculated in the “hybrid” or “accuracy priority” setting.

As described above, according to the third embodiment, a method for evaluating the state of variation of a workspace can be changed in accordance with setting information. The third embodiment allows the user to control a method for evaluating the state of variation of a workspace by their intention. In one example, a user who desires to quickly obtain search results sets the degree-of-variation accuracy setting to “speed priority”. A user who desires accurate search results sets the degree-of-variation accuracy setting to “accuracy priority”. A user who desires to obtain search results based on the latest information with the search processing time reduced to some extent sets the degree-of-variation accuracy setting to “hybrid”.

Next, a fourth embodiment will be described. In the fourth embodiment, differences from the second embodiment will be described. Accordingly, the third embodiment may be similar to the second embodiment unless otherwise specified.

A procedure according to the fourth embodiment will be described with reference to the procedure according to the second embodiment illustrated in FIG. 14. The fourth embodiment is different from the second embodiment in the processing of steps S110a and S170a.

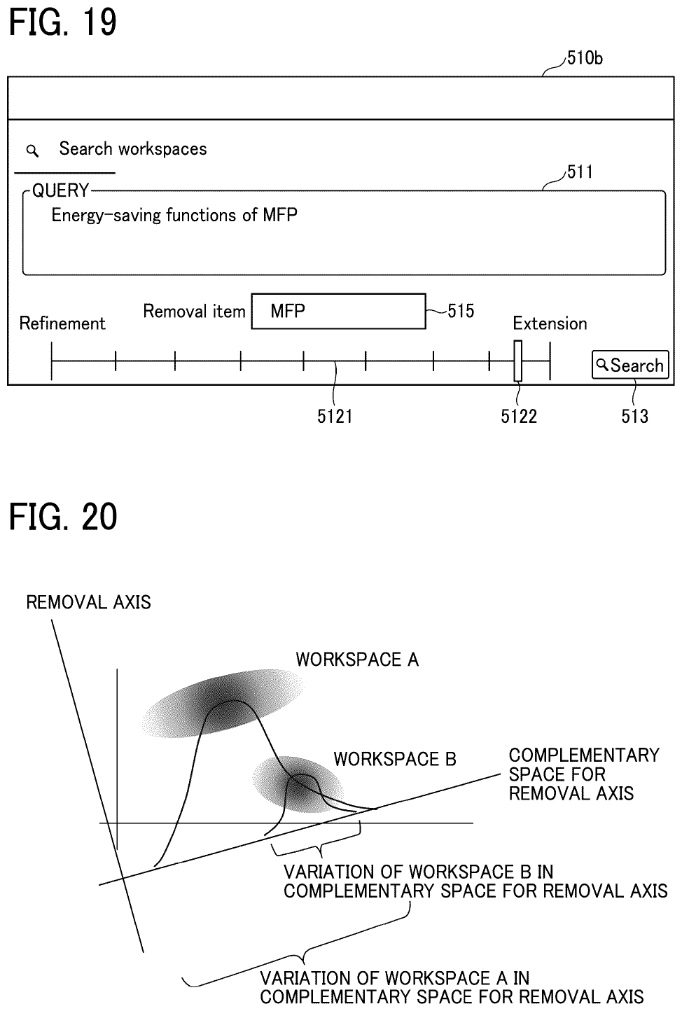

Specifically, in step S110a, the display control unit 31 of the user terminal 30 accepts input of a collection condition from the user via a collection-condition input screen illustrated in FIG. 19.

FIG. 19 illustrates an example of the collection-condition input screen according to the fourth embodiment. In FIG. 19, the same portions as those in FIG. 15 are denoted by the same reference numerals, and descriptions thereof will be omitted. As illustrated in FIG. 19, a collection-condition input screen 510b includes a removal item designation area 515 in place of the evaluation item designation area 514. The removal item designation area 515 is an area for accepting input (designation) of a character string indicating an item (meaning) to be removed (abstracted) from the semantic space to evaluate the states of variations of the workspaces in the semantic space. The character string is hereinafter referred to as “removal item”. In FIG. 19, as an example, the character string “MFP” is input in the removal item designation area 515. Examples of the removal item to be input include a word and any character string (or sentence).

In response to the user pressing the search button 513, the display control unit 31 transmits an information collection request including an information collection condition to the information collection apparatus 10. Specifically, the information collection request includes the input query (i.e., the target query), the designated variation evaluation criterion (i.e., the target variation evaluation criterion), and the input removal item (hereinafter referred to as “target removal item”).

In step S170a, the variation evaluation unit 125 evaluates, for each of the collected workspaces, the state of variation in accordance with the designation. The evaluation of the state of variation in accordance with the designation means that the state of variation is evaluated in a manner similar to that in the first embodiment when no removal item is input. In a case where a target removal item (an example of a third character string) is input, the evaluation of the state of variation in accordance with the designation means that the state of variation is evaluated for the document vectors (an example of first feature information) belonging to each workspace when the feature of the target removal item is removed from the document vectors. The state of variation when the feature of the target removal item is removed refers to the state of variation in a semantic space from which the target removal item is removed.

FIG. 20 illustrates an evaluation of the states of variations of workspaces in a semantic space from which a removal item is removed. In FIG. 20, as in FIG. 8, a semantic space is represented in two dimensions, for convenience.

The semantic space from which a removal item is removed is a complementary space for an axis corresponding to the semantic vector of the removal item in the semantic space. The axis is hereinafter referred to as “removal axis”. In FIG. 20, since the semantic space is represented in two dimensions, the complementary space for the removal axis is represented by a one-dimensional straight line. In practice, however, the complementary space is a space having a number of dimensions obtained by removing one dimension corresponding to the removal axis from the total semantic space (all the dimensions of the semantic vector). In one example, the semantic space (semantic vector) has 1024 dimensions, and the complementary space has 1023 dimensions.

The state of variation of a workspace in the complementary space refers to the state of semantic variation of vectors obtained by projecting the document vectors of the document data belonging to the workspace onto the complementary space. The vectors obtained by such projection are hereinafter referred to as “complementary-space document vectors”. The variation evaluation unit 125 uses the complementary-space document vectors instead of the document vectors to calculate the degree of variation of each workspace by using a method similar to that in the first embodiment. In other words, the degree of variation is based on the number of principal components that reaches a threshold for the cumulative contribution rate.

After step S180, a process similar to that in the first embodiment is executed by using the degrees of variations calculated in step S170a.

For example, the workspaces illustrated in FIG. 9 are taken as an example. When “MFP” is designated as a removal item, document vectors belonging to each of the three workspaces are projected onto a complementary space for the semantic vector of “MFP”. At this time, the states of variations of the three workspaces are evaluated in a space from which the semantic vector of “MFP” is removed. The workspaces “energy-saving functions of MFP” and “energy-saving control of MFP” have content most of which is related to the MFP, and thus have more missing information in the complementary space than the workspace “energy-saving control”. Accordingly, when a variation state evaluation criterion toward “extension” is set, the total score of the workspace “energy-saving control” may be high.

The fourth embodiment may be combined with the third embodiment.

As described above, the fourth embodiment enables evaluation of the states of variations of workspaces in a semantic space from which the meaning related to a removal item is removed, and the display mode of the results of the collected workspaces can be changed in accordance with the result of the evaluation.

Next, a fifth embodiment will be described. In the fifth embodiment, differences from the second or fourth embodiment will be described. Accordingly, the fifth embodiment may be similar to the second or fourth embodiment unless otherwise specified. A procedure according to the fifth embodiment will be described with reference to the procedure according to the second embodiment illustrated in FIG. 14. The fifth embodiment is different from the second embodiment in the processing of steps S110a and S170a.

The fifth embodiment enables designation of both the evaluation item described in the second embodiment and the removal item described in the fourth embodiment. In step S110a, the display control unit 31 of the user terminal 30 accepts input of a collection condition from the user via a collection-condition input screen. The collection-condition input screen is generated by adding the evaluation item designation area 514 illustrated in FIG. 15 to the collection-condition input screen 510b illustrated in FIG. 19. In response to the user pressing the search button 513, the display control unit 31 transmits an information collection request including an information collection condition to the information collection apparatus 10. Specifically, the information collection request includes the input query (i.e., the target query), the designated variation evaluation criterion (i.e., the target variation evaluation criterion), the input evaluation item (i.e., the target evaluation item), and the input removal item (i.e., the target removal item).

In step S170a, the variation evaluation unit 125 evaluates, for each of the collected workspaces, the state of variation in accordance with the designation. The evaluation of the state of variation in accordance with the designation means that the state of variation is evaluated in a manner similar to that in the first embodiment when no evaluation item or removal item is input. In a case where an evaluation item is input but no removal item is input, the evaluation of the state of variation in accordance with the designation refers to the evaluation of the state of variation in a manner similar to that in the second embodiment. In a case where a removal item is input but no evaluation item is input, the evaluation of the state of variation in accordance with the designation refers to the evaluation of the state of variation in a manner similar to that in the fourth embodiment.

In a case where both an evaluation item (an example of a second character string) and a removal item (an example of a third character string) are input, the variation evaluation unit 125 evaluates, for document vectors (an example of first feature information) belonging to each workspace, the state of variation for the feature of the target evaluation item in a case where the feature of the target removal item is removed from the document vectors. Specifically, the variation evaluation unit 125 calculates, as the degree of variation of each workspace, the variance of scalar values obtained by projecting the document vectors belonging to the workspace onto the evaluation axis corresponding to the target evaluation item in a complementary space (a semantic space from which the feature of the removal item is removed) for the removal axis corresponding to the target removal item.

After step S180, a process similar to that in the first embodiment is executed by using the degrees of variations calculated in step S170a.

The fifth embodiment may be combined with the third embodiment.

As described above, the fifth embodiment provides a combination of the effect of the second embodiment and the effect of the fourth embodiment.

Next, a sixth embodiment will be described. In the sixth embodiment, differences from the first embodiment will be described. Accordingly, the sixth embodiment may be similar to the first embodiment unless otherwise specified.

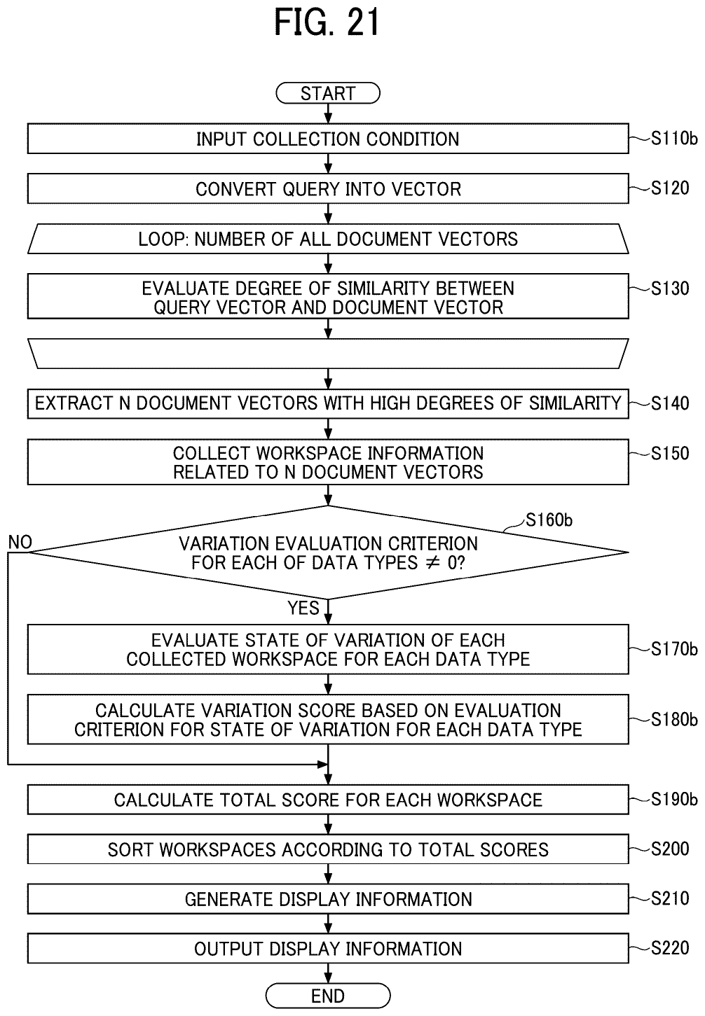

FIG. 21 is a flowchart illustrating an example procedure of an information collection process according to the sixth embodiment. In FIG. 21, the same steps as those in FIG. 4 are denoted by the same step numerals, and descriptions thereof will be omitted.

In FIG. 21, steps S110, S160, S170, S180, and S190 in FIG. 4 are replaced with steps S110b, S160b, S170b, S180b, and S190b, respectively.

The collection-condition input screen 510 (FIG. 5) according to the sixth embodiment includes the variation evaluation criterion designation area 512 for each type of document data (hereinafter referred to as “data type”). The data type is a type of document data that is distinguished based on the content or attribute of the document data. Examples of the type include “meeting minutes”, “specifications”, and “daily report”. Alternatively, the data type may be distinguished based on the source from which the document data is generated (where the document data is recorded). For example, the data type may be distinguished based on whether the data type is meeting minutes recorded by a specific conference device. The data types may be stored in the document information storage unit 21 in association with the document IDs of the items of document data.

In step S110b, the display control unit 31 of the user terminal 30 transmits an information collection request (target collection request) including, as information collection conditions, the input query and a variation evaluation criterion for each data type to the information collection apparatus 10.

In step S160b, the variation evaluation unit 125 determines whether the value of the variation evaluation criterion for each of the data types included in the target collection request is non-zero. If the values of the variation evaluation criteria for all of the data types are zero (No in S160b), the process proceeds to step S190b. If the value of the variation evaluation criterion for any of the data types is non-zero (Yes in S160b), the processing of steps S170b and S180b is executed, and then the process proceeds to step S190b.

In step S170b, the variation evaluation unit 125 evaluates the state of variation for each collection of document data of a data type for which the variation evaluation criterion is non-zero (that is, for each data type) among the items of document data belonging to each of the collected workspaces. The degree of variation for a collection of document data of a certain data type is calculated in a way similar to that in the first embodiment.

In one example, a document data group of data type 1 and a document data group of data type 2 belong to a certain workspace. In this case, if the variation evaluation criterion for the data type 1 is non-zero, the variation evaluation unit 125 calculates the degree of variation for the document data group of the data type 1 by using the same method as the method for calculating the degree of variation of the workspace according to the first embodiment. If the variation evaluation criterion for the data type 2 is non-zero, the variation evaluation unit 125 calculates the degree of variation for the document data group of the data type 2 by using the same method as the method for calculating the degree of variation of the workspace according to the first embodiment.

In step S180b, the variation evaluation unit 125 converts, for each of the collected workspaces and for each of the data types, the degree of variation for the data type into a variation score in accordance with a variation evaluation criterion designated for the data type. The method for conversion of the degree of variation into a variation score may be similar to that in the first embodiment. In step S180b, unlike the first embodiment, a variation score is calculated not for each workspace but for each data type for each workspace.

In step S190b, the total evaluation unit 126 calculates a total score for each of the collected workspaces. When the degree of similarity between a certain workspace and the target query is x, the variation score of a data type i for which a variation evaluation criterion is designated among the data types belonging to the certain workspace is yi, and the number of data types i belonging to the certain workspace is K, for example, the total score of the certain workspace may be calculated in the following way.

$$Total score = {x}^{′} + \sum ( α i \times {yi}^{′} ) \div K ,$$

where Σ is the sum of (αi×yi′) for all of the data types i belonging to the certain workspace, x′ and yi′ are normalized values of x and yi, respectively, to make the scales (the range from the minimum value to the maximum value) of x and yi match, and αi is the absolute value of the variation evaluation criterion for the data type i.

In step S210, the display information generation unit 127 generates display information of the search result screen 520. The search result screen 520 displays a collection of document data of each data type in a mode based on the evaluation results of the similarity and a result of application of the state of variation of the document vectors (an example of first feature information) for the data type to the variation evaluation criterion for the data type.

The sixth embodiment may be combined with any one of the second to fifth embodiments.

As described above, in the sixth embodiment, the display mode of the results of the collected workspaces can be changed in accordance with the state of semantic variation in document data of a specific data type.

Next, a seventh embodiment will be described. In the seventh embodiment, differences from the first embodiment will be described. Accordingly, the seventh embodiment may be similar to the first embodiment unless otherwise specified.

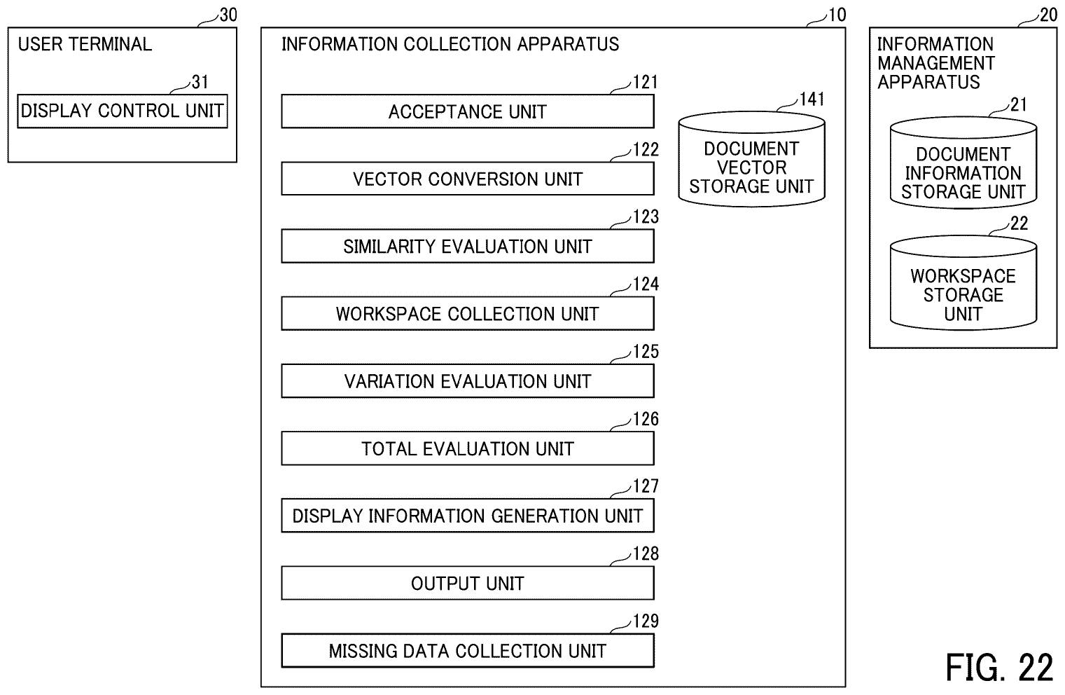

FIG. 22 is a diagram illustrating an example functional configuration of an information processing system according to the seventh embodiment. In FIG. 22, the same components as those in FIG. 3 are denoted by the same reference numerals, and descriptions thereof will be omitted.

In FIG. 22, the information collection apparatus 10 further includes a missing data collection unit 129. The missing data collection unit 129 collects data based on a principal component having a relatively low contribution rate among principal components obtained from principal component analysis of document vectors (an example of first feature information) of document data (an example of data) belonging to a certain workspace (an example of a collection of data) to collect missing data of the certain workspace. The workspace is a collection of document information (document data) retrieved based on a certain query. A user is allowed to add or delete document information to or from the workspace. Accordingly, the workspace is also referred to as a collection of data created by the user with any intention. The missing data collection unit 129 collects information related to data estimated to be insufficient for the user's intention from various information sources.

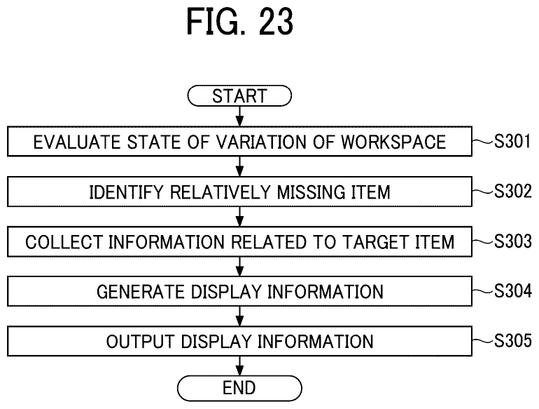

FIG. 23 is a flowchart illustrating an example procedure of a process performed by the information collection apparatus 10 according to the seventh embodiment. The procedure illustrated in FIG. 23 is executed in response to, for example, pressing of a “Details” button for any one of the workspaces (hereinafter referred to as “target workspace”) in the search result display areas 523 of the search result screen 520 (FIG. 11). In this case, the display control unit 31 of the user terminal 30 transmits the workspace ID of the target workspace to the information collection apparatus 10.

In response to the acceptance unit 121 of the information collection apparatus 10 receiving the workspace ID of the target workspace, the variation evaluation unit 125 evaluates the state of variation of the target workspace (S301). The method for evaluation of the state of variation of the target workspace is similar to that in step S170 in FIG. 4. Accordingly, if the processing of step S170 has already been performed on the target workspace, the evaluation result obtained in step S170 may be used in and after step S302.

Then, the missing data collection unit 129 identifies a missing item for the target workspace, based on the results of the principal component analysis executed in the evaluation of the state of variation of the target workspace (S302). Specifically, the missing data collection unit 129 identifies, as the missing item, a principal component having a relatively low contribution rate (hereinafter referred to as “target principal component”) among the principal components obtained from the principal component analysis. In one example, L principal components from the lowest contribution rate are identified as target principal components. In another example, principal components having contribution rates less than or equal to a threshold are identified as target principal components.

Then, the missing data collection unit 129 collects data related to each of the target principal components (S303). The data related to a certain principal component is data for which the degree of similarity (e.g., cosine similarity) between the certain principal component and the semantic vector of the data is less than or equal to a threshold. Possible examples of such data include document data, web pages, book information, and combinations thereof. For the document data, in one example, each document vector stored in the document vector storage unit 141 (FIG. 6) is set as the target for calculating the degree of similarity to the target principal component. For the web pages, in one example, a semantic vector of a text of content displayed in each web page accessed by a predetermined method is set as the target for calculating the degree of similarity to the target principal component. For the book information, in one example, a semantic vector of a review of a book in a book sales website registered in advance is set as the target for calculating the degree of similarity to the target principal component.

Then, the display information generation unit 127 generates display information of a screen that prompts (suggests) replenishment of the target workspace with the data collected by the missing data collection unit 129 (S304). In one embodiment, the display information generation unit 127 generates, for book information, display information including information (e.g., a message) that prompts the purchase of the book.

Then, the output unit 128 transmits the display information to the user terminal 30 (S305). The display control unit 31 of the user terminal 30 displays the screen based on the display information. In one embodiment, the user refers to the screen and checks missing data for the target workspace.

As described above, the seventh embodiment provides assistance for further making the content of a workspace match the user's intention.

Like the first embodiment, the second to seventh embodiments further improve the convenience of information collection.

The information collection apparatus 10 is not limited to a general-purpose computer and may be any apparatus including the processor 104. Examples of the information collection apparatus 10 include, but are not limited to, an image forming apparatus, an output device such as a projector (PJ), an interactive whiteboard (IWB), which is an electronic whiteboard having mutual communication capability, and a digital signage, a head-up display (HUD) device, an industrial machine, an imaging device, a sound collecting device, a medical device, a networked home appliance, a laptop PC, a mobile phone, a smartphone, a tablet terminal, a game console, a personal digital assistant (PDA), a digital camera, a wearable PC, and a desktop PC.

In the embodiments described above, workspaces may be generated by a learning effect of machine learning. Machine learning is a technology for making a computer acquire human-like learning ability. Machine learning refers to a technology in which a computer autonomously generates an algorithm to be used for determination such as data identification from training data captured in advance and applies the generated algorithm to new data to make a prediction. Any suitable learning method is applied for machine learning. For example, any one of supervised learning, unsupervised learning, semi-supervised learning, reinforcement learning, and deep learning, or a combination of two or more of those learning methods may be used.

The functionality of the elements disclosed herein may be implemented using circuitry or processing circuitry which includes general purpose processors, special purpose processors, integrated circuits, ASICs (“Application Specific Integrated Circuits”), FPGAs (“Field-Programmable Gate Arrays”), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of a FPGA or ASIC.

The apparatuses or devices described in the embodiments are merely representative of one of multiple computing environments that implement one or more embodiments disclosed herein.

In some embodiments, the information collection apparatus 10 includes multiple computing devices such as a server cluster. The multiple computing devices are configured to communicate with one another through any type of communication link including, for example, a network and a shared memory, and perform the processes disclosed herein. The user terminal 30 may also include multiple computing devices configured to communicate with one another.

In one embodiment, the information collection apparatus 10 and the user terminal 30 are configured to share the processing steps disclosed herein, for example, the processing steps illustrated in FIGS. 4, 14, 18, 21 and 23, in various combinations. In one example, a process executed by a predetermined unit may be executed by the user terminal 30. The functions of the predetermined unit may be implemented by the user terminal 30. The components of each of the information collection apparatus 10 and the user terminal 30 may be integrated into one server apparatus or divided into a plurality of apparatuses.

In one or more embodiments of the present disclosure, the information collection apparatus 10 is an example of an information processing apparatus and an information processing system.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The following non-limiting examples illustrate aspects of the present disclosure.

In a first aspect, an information processing apparatus includes a similarity evaluation unit, a variation evaluation unit, and a display information generation unit. The similarity evaluation unit evaluates similarity between first feature information and second feature information for each of multiple items of data. The first feature information indicates a feature of the data. The second feature information indicates a feature of a first character string designated in input information. The variation evaluation unit evaluates, for a collection of data including the multiple items of data, a state of variation of the first feature information of the items of data belonging to the collection of data. The display information generation unit generates display information of a screen that displays the collection of data in a mode based on a result of evaluation of the similarity and a result of evaluation of the state of variation.

According to a second aspect, in the information processing apparatus of the first aspect, the display information generation unit generates display information of a screen that displays the collection of data in a mode based on the result of evaluation of the similarity and a result of application of the state of variation of the first feature information to an evaluation criterion for the state of variation. The evaluation criterion for the state of variation is designated in the input information.

According to a third aspect, in the information processing apparatus of the first aspect or the second aspect, the variation evaluation unit evaluates the state of variation, based on contribution rates of principal components obtained from principal component analysis of the first feature information of the items of data belonging to the collection of data and a threshold for a cumulative value of one or more high contribution rates among the contribution rates.

According to a fourth aspect, in the information processing apparatus of any one of the first to third aspects, the variation evaluation unit acquires a result of evaluation of the state of variation before the input information is input, in accordance with preset information.

According to a fifth aspect, in the information processing apparatus of the second aspect, the evaluation criterion for the state of variation includes any one of assigning a rating to the state of variation such that the rating increases as a variation increases, assigning a rating to the state of variation such that the rating increases as a variation decreases, and assigning no rating to the state of variation.

According to a sixth aspect, in the information processing apparatus of any one of the first to fifth aspects, the input information includes a second character string, and the variation evaluation unit evaluates, for the first feature information, a state of variation for a feature of the second character string.

According to a seventh aspect, in the information processing apparatus of the second aspect, in response to a change of the evaluation criterion to another evaluation criterion after generation of the display information of the screen, the display information generation unit generates display information of a screen that displays the collection of data in a mode based on the result of evaluation of the similarity and a result of application of the state of variation of the first feature information to said another evaluation criterion.

According to an eighth aspect, in the information processing apparatus of any one of the first to seventh aspects, the input information includes a third character string, and the variation evaluation unit evaluates a state of variation of the first feature information in a case where a feature of the third character string is removed.

According to a ninth aspect, in the information processing apparatus of any one of the first to eighth aspects, the input information includes a second character string and a third character string, and the variation evaluation unit evaluates, for the first feature information, a state of variation for a feature of the second character string in a case where a feature of the third character string is removed.

According to a tenth aspect, in the information processing apparatus of the second aspect, the input information includes the evaluation criterion for each type of data, the variation evaluation unit evaluates, for each of multiple collections of data, a state of variation of the first feature information for each of types of data belonging to the collection of data, the multiple collections of data including the collection of data including the multiple items of data, and the display information generation unit generates display information of a screen that displays the multiple collections of data in a mode based on the result of evaluation of the similarity and a result of application of the state of variation of the first feature information for each of the types of the data to the evaluation criterion for the type of the data.

According to an eleventh aspect, the information processing apparatus of any one of the first to tenth aspects further includes a missing data collection unit and an output unit. The missing data collection unit collects data based on a principal component having a relatively low contribution rate among principal components obtained from principal component analysis of the first feature information of the items of data belonging to any one of the collections of data. The output unit outputs information related to the data collected by the missing data collection unit.

According to a twelfth aspect, in the information processing apparatus of the eleventh aspect, the output unit outputs information that prompts purchase of a book related to the data collected based on the principal component having the relatively low contribution rate.

According to a thirteenth aspect, in the information processing apparatus of any one of the first to twelfth aspects, the display information generation unit generates display information of a screen indicating the state of variation.

In a fourteenth aspect, an information processing system includes a similarity evaluation unit, a variation evaluation unit, and a display information generation unit. The similarity evaluation unit evaluates similarity between first feature information and second feature information for each of multiple items of data. The first feature information indicates a feature of the data. The second feature information indicates a feature of a first character string designated in input information. The variation evaluation unit evaluates, for a collection of data including the multiple items of data, a state of variation of the first feature information of the items of data belonging to the collection of data. The display information generation unit generates display information of a screen that displays the collection of data in a mode based on a result of evaluation of the similarity and a result of evaluation of the state of variation.

In a fifteenth aspect, an information processing method includes evaluating similarity between first feature information and second feature information for each of multiple items of data, the first feature information indicating a feature of the data, the second feature information indicating a feature of a first character string designated in input information; evaluating, for a collection of data including the multiple items of data, a state of variation of the first feature information of the items of data belonging to the collection of data; and generating display information of a screen that displays the collection of data in a mode based on a result of evaluation of the similarity and a result of evaluation of the state of variation.

In a sixteenth aspect, a program causes a computer to execute evaluating similarity between first feature information and second feature information for each of multiple items of data, the first feature information indicating a feature of the data, the second feature information indicating a feature of a first character string designated in input information; evaluating, for a collection of data including the multiple items of data, a state of variation of the first feature information of the items of data belonging to the collection of data; and generating display information of a screen that displays the collection of data in a mode based on a result of evaluation of the similarity and a result of evaluation of the state of variation.

1. An information processing apparatus comprising:
circuitry configured to:
evaluate similarity between first feature information and second feature information for each of multiple items of data, the first feature information indicating a feature of the data, the second feature information indicating a feature of a first character string designated in input information;
evaluate, for a collection of data including the multiple items of data, a state of variation of the first feature information of the items of data belonging to the collection of data; and
generate display information of a screen that displays the collection of data in a mode based on a result of evaluation of the similarity and a result of evaluation of the state of variation.

2. The information processing apparatus according to claim 1, wherein
the circuitry is configured to generate display information of a screen that displays the collection of data in a mode based on the result of evaluation of the similarity and a result of application of the state of variation of the first feature information to an evaluation criterion for the state of variation, the evaluation criterion for the state of variation being designated in the input information.

3. The information processing apparatus according to claim 1, wherein
the circuitry is configured to evaluate the state of variation, based on contribution rates of principal components obtained from principal component analysis of the first feature information of the items of data belonging to the collection of data and a threshold for a cumulative value of one or more high contribution rates among the contribution rates.

4. The information processing apparatus according to claim 1, wherein
the circuitry is configured to acquire a result of evaluation of the state of variation before the input information is input, in accordance with preset information.

5. The information processing apparatus according to claim 2, wherein
the evaluation criterion for the state of variation includes any one of:
assigning a rating to the state of variation such that the rating increases as a variation increases;
assigning a rating to the state of variation such that the rating increases as a variation decreases; and
assigning no rating to the state of variation.

6. The information processing apparatus according to claim 1, wherein
the input information includes a second character string, and
the circuitry is configured to evaluate, for the first feature information, a state of variation for a feature of the second character string.

7. The information processing apparatus according to claim 2, wherein
the circuitry is configured to, in response to a change of the evaluation criterion to another evaluation criterion after generation of the display information of the screen, generate display information of a screen that displays the collection of data in a mode based on the result of evaluation of the similarity and a result of application of the state of variation of the first feature information to said another evaluation criterion.

8. The information processing apparatus according to claim 1, wherein
the input information includes a third character string, and
the circuitry is configured to evaluate a state of variation of the first feature information in a case where a feature of the third character string is removed.

9. The information processing apparatus according to claim 1, wherein
the input information includes a second character string and a third character string, and
the circuitry is configured to evaluate, for the first feature information, a state of variation for a feature of the second character string in a case where a feature of the third character string is removed.

10. The information processing apparatus according to claim 2, wherein
the input information includes the evaluation criterion for each type of data, and
the circuitry is configured to:
evaluate, for each of multiple collections of data, a state of variation of the first feature information for each of types of data belonging to the collection of data, the multiple collections of data including the collection of data including the multiple items of data; and
generate display information of a screen that displays the multiple collections of data in a mode based on the result of evaluation of the similarity and a result of application of the state of variation of the first feature information for each of the types of the data to the evaluation criterion for the type of the data.

11. The information processing apparatus according to claim 10, wherein
the circuitry is configured to:
collect data based on a principal component having a relatively low contribution rate among principal components obtained from principal component analysis of the first feature information of the items of data belonging to one or more of the collections of data; and
output information related to the collected data.

12. The information processing apparatus according to claim 11, wherein
the circuitry is configured to output information that prompts purchase of a book related to the data collected based on the principal component having the relatively low contribution rate.

13. The information processing apparatus according to claim 1, wherein
the circuitry is configured to generate display information of a screen indicating the state of variation.

14. An information processing system comprising:
circuitry configured to:
evaluate similarity between first feature information and second feature information for each of multiple items of data, the first feature information indicating a feature of the data, the second feature information indicating a feature of a first character string designated in input information;
evaluate, for a collection of data including the multiple items of data, a state of variation of the first feature information of the items of data belonging to the collection of data; and
cause a display to display a screen that displays the collection of data in a mode based on a result of evaluation of the similarity and a result of evaluation of the state of variation.

15. An information processing method comprising:
evaluating similarity between first feature information and second feature information for each of multiple items of data, the first feature information indicating a feature of the data, the second feature information indicating a feature of a first character string designated in input information;
evaluating, for a collection of data including the multiple items of data, a state of variation of the first feature information of the items of data belonging to the collection of data; and
generating display information of a screen that displays the collection of data in a mode based on a result of evaluation of the similarity and a result of evaluation of the state of variation.

16. A non-transitory recording medium storing a plurality of instructions which, when executed by one or more processors, causes the processors to perform the information processing method according to claim 15.
